(19) United States
(12) Patent Application Publication
(10) Pub. No.: US 2026/0146768 A1
(43) Pub. Date: May 28, 2026

(54) LOW GWP REFRIGERANTS, AND SYSTEMS FOR AND METHODS OF PROVIDING REFRIGERATION

(71) Applicant: HONEYWELL INTERNATIONAL INC., Charlotte, NC (US)

(72) Inventors: Hongqing JIN, Buffalo, NY (US); Kaimi GAO, Buffalo, NY (US); Nilesh PUROHIT, Buffalo, NY (US); Nitin KARWA, Buffalo, NY (US); Elizabet Del Carmen VERA BECERRA, Buffalo, NY (US)

(73) Assignee: HONEYWELL INTERNATIONAL INC., Charlotte, NC (US)

(21) Appl. No.: 19/254,218

(22) Filed: Jun. 30, 2025

Related U.S. Application Data
(60) Provisional application No. 63/725,155, filed on Nov. 26, 2024.

(51) Int. Cl. F25B 9/00; C09K 5/04

(52) U.S. Cl. CPC F25B 9/006; C09K 5/044; C09K 2205/122; C09K 2205/22

(57) ABSTRACT

The present invention provides a refrigerant composition comprising from about 50% to less than 65% by weight of HFO-1234ze(E), from 1% to less than 12.5% by weight of HFC-134a, and from about 25% to about 42% of HFCO-1233zd(E).

### CROSS-REFERENCE TO RELATED APPLICATIONS

The present application claims the benefit of priority to U.S. Provisional Patent Application No. 63/725,155, filed Nov. 26, 2024, the disclosure of which is incorporated by reference in its entirety.

### FIELD OF THE INVENTION

The present invention relates to high efficiency, low-global warming potential (“low GWP”) refrigerants and to air conditioning systems, heat pump systems and/or refrigeration systems and methods for providing cooling that are safe and effective.

### BACKGROUND

The refrigeration industry is under increasing pressure—through regulatory changes and otherwise—to replace high global warming potential (GWP) refrigerants, such as R134a and R404A, with low GWP refrigerants, such as refrigerants with GWP below 150. This is of particular importance in heat transfer systems in which high volumes of high GWP refrigerant have previously been used, such as in the case of commercial refrigeration systems, commercial air conditioning, transport refrigeration systems, high temperature heat pumps and the like.

One approach has been to use low GWP refrigerants, such as carbon dioxide (R744) and hydrocarbon refrigerants. However, such an approach as has been heretofore used can suffer from significant safety and financial drawbacks, such as: poor system energy efficiency, leading to increased operating costs; high system complexity, leading to high initial system costs; low system serviceability and reliability, leading to high maintenance costs; and high system flammability. Systems which use refrigerants that include components having unacceptable or unknown toxicity are also problematic from a safety standpoint. Use of highly flammable refrigerants and/or refrigerants with high or even uncertain toxicity in such systems have been particularly disadvantageous as they can also lead to poor levels of safety; can conflict with regulatory code restrictions; and can increase liability on refrigeration system operators and manufacturers. Safety is a particular concern given that many commercial refrigeration applications, such as supermarket fridges, freezers and cold display cases, are publicly accessible and often operate in densely populated spaces.

Creating new refrigerants meeting environmental demands while having the necessary mosaic of advantageous performance properties has represented a huge and complex challenge to industry. Improving one performance property often worsens performance in another category, exacerbated by individual commercial applications often placing their own specific demands on the refrigerant.

For example, heat transfer fluids such as R134a and R404A, have been used in large distributed direct expansion refrigeration systems for commercial use, such as supermarkets, for low or medium temperature applications. However, many of these refrigerants have unacceptably high Global Warming Potentials (GWPs) according to IPCC AR5. For example, R404A has a GWP of 3940 and R134a has a GWP of 1300. Since it is likely that the fittings, hoses and/or pieces of equipment in such systems will eventually leak, such environmentally damaging refrigerants will likely escape to the atmosphere. Moreover, since long conduit runs involve more pipefitting joints, valves and the like that may potentially leak, when a leak does occur, the longer the conduit run, the larger the quantity of high GWP refrigerant will be lost to the atmosphere.

US 2021/0198547 suggests refrigerant blends as possible lower GWP replacements for HFC-134a. One such refrigerant comprises a blend of 63% by weight of HFO-1234ze, 2% by weight of HFCO-1233zd, and 35% by weight of 1,1,2,2-tetrafluoroethane. However, this refrigerant blend has a GWP of 394, which is more than double the target of 150 GWP (see Table 2). The lowest GWP of any blend shown in Table 2 of the '547 patent application is 334, which is if for a binary blend of 70% by weight of HFO-1234ze and 30% by weight of 1,1,2,2-tetrafluoroethane. However, this GWP value is still more than double the target of 150 GWP, and furthermore this blend is reported to be flammable.

U.S. Pat. No. 9,410,024, which is assigned to the assignee of the present invention, discloses compositions comprising from 80% to 99.9% by weight of 1234ze and 0.1 to 20% by weight of 1233zd as replacements for HFC-134a in some applications, but the compositions contemplated by the '024 patent are described as having a GWP of up to 1000 and as possibly not being class A1. In addition, applicants have come to appreciate that the blends disclosed in the '024 patent may, in some important applications, have undesirably low operating pressures (including possibly below atmospheric, which is highly undesirably) and potentially high glides. Similar blends are disclosed in U.S. Pat. No. 9,394,469, which is also assigned to the assignee of the present applications.

Efforts to develop a refrigerant that overcomes the environmental deficiencies of HFC-134a, including in distributed refrigeration systems, while also having the necessary combination of other important properties such as non-flammability, acceptable toxicity and desirable heat transfer and operating properties, present a substantial engineering challenge which has not heretofore been acceptably achieved.

Moreover, in large distributed refrigeration systems containing conventional roof-mounted or machine room condenser/compressor systems provide high levels of efficiency and capacity, and applicants have come to appreciate that modification of such systems to be more environmentally attractive should desirably maintain this efficiency and capacity.

Applicants have come to appreciate, therefore, that the refrigeration industry continues to need safe, robust, efficient and sustainable approaches for reducing the use of high GWP refrigerants which can be used with existing technologies.

One such approach that has been previously used is shown in FIG. 1A. FIG. 1A shows a refrigeration system which is commonly used for commercial refrigeration in supermarkets.

Applicants have come to appreciate that it is also difficult in many applications to identify a single-component fluid that possesses the full set of properties that make it of particular advantage in applications of the type discussed above. For example, in many important applications, it is necessary to identify a refrigerant that simultaneously: (1) is non-flammable (i.e., Class A1) and; (2) has acceptable toxicity and/or does not contain components with unknown toxicity; (3) has low global warming potential (GWP) (i.e., about 150 or less), and (4) has heat transfer properties (including preferably COP and/or efficiency) and other properties (such as chemical stability) that match the needs of the particular application, especially in medium temperature heat transfer systems. Those skilled in the art have found it difficult (if not impossible) to heretofore find a refrigerant (whether single component or otherwise) that can at once satisfy items (1), (2), and (3), and preferably also item (4). Here a non-flammable substance would be classified as class “1” by ASHRAE and an acceptable toxicity substance is classified as class “A” by ASHRAE Standard 34-2022. A substance which is non-flammable and acceptable toxicity would be classified as “A1” by ASHRAE Standard 34-2022.

For example, while a refrigerant consisting of HFC-134a has heretofore been used for certain no-freeze applications, it nevertheless fails to satisfy, for example, the low GWP requirement (item 5 above), as HFC-134a has a GWP of about 1300.

Applicants proceeded in a manner contrary to the accepted wisdom and discovered unexpected and advantageous results. For example, applicants have found, as described in detail hereinafter, that certain blends comprising a carefully selected combination of components can have an advantageous but unexpected combination of properties, including low GWP (i.e., a GWP of less than about 150), acceptable toxicity, chemical stability, lubricant compatibility, and non-flammability, that is, class A1. Furthermore, applicants have found that the refrigerant compositions of the present invention have particular advantage for use in many varied applications, including but not limited to medium temperature refrigeration systems, and particularly in medium temperature refrigeration systems that are in a cascaded refrigeration system.

### SUMMARY

Applicants have discovered refrigerant compositions, heat transfer compositions comprising the refrigerant, refrigeration methods and systems, including cascade heat transfer methods and systems, and/or to methods and systems for providing cooling, including but not limited to low temperature refrigeration, medium temperature refrigeration and air conditioning application, especially in applications in which either HFC-134a or R404A has previously been used.

Thus, the present invention preferably provides non-flammable, non-toxic refrigerant compositions (i.e., Class A1) having global warming potentials (GWPs) of 150 or less and at the same time excellent heat transfer efficiency compared to previously used refrigerants R-134a and R404a in a wide variety of refrigeration applications, including in medium temperature refrigeration systems and methods, low temperature refrigeration systems and methods, cascade refrigeration systems and methods (including micro-cascade refrigeration systems and methods), vending machines, heat pump water heaters, mobile air conditioning systems and methods, stationary air conditioning systems and methods (including commercial air conditioning systems and methods), transport refrigeration, heat pipe cooling (including cooling of electronics using heat pipes), cold plate cooling (including cooling of electronics using cold plates), and high temperature heat pumps, and in methods for heating and/or cooling using a replacement refrigerant comprising a refrigerant of the present invention in an R-134a system and/or an R-404A system.

The present invention also includes methods of improving heat transfer systems, including but not limited to distributed refrigeration systems, that enable the skilled person to replace an existing refrigerant having a high GWP with a lower GWP refrigerant, whilst maintaining acceptable thermodynamic performance (notably operating efficiency) and with only relatively small changes to system infrastructure. Minimizing the changes to major components of the system infrastructure, such as for example the compressor in the indoor units, is particularly attractive because it minimizes the amount of equipment downtime and financial capital cost expenditure associated with the method.

The present invention also includes each of the refrigeration systems and methods identified in the preceding paragraph, as described in detail hereinafter.

The refrigerants of the present invention include refrigerants, classified as A1 (non-flammable and acceptable toxicity) by ASHRAE and which also have a GWP of about 150 or less. The refrigerants of the present invention are not only A1 refrigerants with a 150 or less GWP, which is itself an unexpected result, but additionally are able to provide excellent efficiency (i.e., COP) operating in a wide range of refrigeration systems and methods.

The present invention includes refrigerants consisting essentially of:
(a) from about 50% to 70% by weight of HFO-1234ze(E);
(b) from 1% to less than 10.5% by weight of HFC-134a; and
(c) from about 19.5% to about 42% of HFCO-1233zd(E).

The refrigerant according to this paragraph is sometimes referred to herein for convenience as Refrigerant 1A.

The present invention also includes refrigerants consisting essentially of:
(a) from about 50% to less than 60% by weight of HFO-1234ze(E),
(b) from 1% to 10% by weight of HFC-134a; and
(c) from 30% to about 35% of HFCO-1233zd(E).

The refrigerant according to this paragraph is sometimes referred to herein for convenience as Refrigerant 1B.

The present invention also includes refrigerants consisting of:
(a) from about 50% to less than 65% by weight of HFO-1234ze(E),
(b) from 1% to 10% by weight of HFC-134a; and
(c) from about 25% to about 35% of HFCO-1233zd(E).

The refrigerant according to this paragraph is sometimes referred to herein for convenience as Refrigerant 1C.

The present invention also includes refrigerants consisting essentially of:
(a) from about 50% to less than 70% by weight of HFO-1234ze(E),
(b) from about 9% to 10.5% by weight of HFC-134a; and
(c) from about 19.5% to about 36% of HFCO-1233zd(E), provided said refrigerant is an A1 refrigerant and has a GWP of 150 or less. The refrigerant according to this paragraph is sometimes referred to herein for convenience as Refrigerant 2A.

The present invention also includes refrigerants consisting essentially of:
(a) from about 56% to less than 64% by weight of HFO-1234ze(E),
(b) from 8% to 10.5% by weight of HFC-134a; and
(c) from about 26% to about 36% of HFCO-1233zd(E), wherein said refrigerant is an A1 refrigerant.

The refrigerant according to this paragraph is sometimes referred to herein for convenience as Refrigerant 2B.

The present invention also includes refrigerants consisting of:
(a) from about 56% to less than 64% by weight of HFO-1234ze(E),
(b) from 8% to 10.5% by weight of HFC-134a; and
(c) from about 26% to about 36% of HFCO-1233zd(E), wherein said refrigerant has a GWP of 150 or less.

The refrigerant according to this paragraph is sometimes referred to herein for convenience as Refrigerant 2C.

The present invention also includes refrigerants consisting essentially of:
(a) 60%+0.3%/−2.0% by weight of HFO-1234ze(E),
(b) 10%+1.5%/−0.5% by weight of HFC-134a; and
(c) 30%+1.5%/−0.5% of HFCO-1233zd(E).

The refrigerant according to this paragraph is sometimes referred to herein for convenience as Refrigerant 3A.

The present invention also includes refrigerants consisting essentially of:
(a) from 58% to 61% by weight of HFO-1234ze(E),
(b) from 9% to 10% by weight of HFC-134a; and
(c) from about 29% to 32% of HFCO-1233zd(E).

The refrigerant according to this paragraph is sometimes referred to herein for convenience as Refrigerant 3B.

The present invention also includes refrigerants consisting essentially of:
(a) from 58% to 61% by weight of HFO-1234ze(E),
(b) from 9% to 10.5% by weight of HFC-134a; and
(c) from about 29% to 32% of HFCO-1233zd(E),
   wherein said refrigerant is an A1 refrigerant and has a GWP of 150 or less.

The refrigerant according to this paragraph is sometimes referred to herein for convenience as Refrigerant 3C.

The present invention also includes refrigerants consisting of:
(a) 60%+0.3%/−2.0% by weight of HFO-1234ze(E),
(b) 9%+1.5%/−0.5% by weight of HFC-134a; and
(c) 31%+1.5%/−0.5% of HFCO-1233zd(E).

The refrigerant according to this paragraph is sometimes referred to herein for convenience as Refrigerant 4A.

The present invention also includes refrigerants consisting essentially of:
(a) from 58% to 61% by weight of HFO-1234ze(E),
(b) from 8% to 10% by weight of HFC-134a; and
(c) from 30% to 33% by weight of HFCO-1233zd(E).

The refrigerant according to this paragraph is sometimes referred to herein for convenience as Refrigerant 4B.

The present invention also includes refrigerants consisting essentially of:
(a) from 58% to 61% by weight of HFO-1234ze(E),
(b) from 8% to 10.5% by weight of HFC-134a; and
(c) from 30% to 33% by weight of HFCO-1233zd(E),
   wherein said refrigerant is an A1 refrigerant and has a GWP of 150 or less.

The refrigerant according to this paragraph is sometimes referred to herein for convenience as Refrigerant 4C.

The present invention also includes refrigerants consisting of:
(a) 62%+0.3%/−2.0% by weight of HFO-1234ze(E),
(b) 10%+1.5%/−0.5% by weight of HFC-134a; and
(c) 28%+1.5%/−0.5% of HFCO-1233zd(E).

The refrigerant according to this paragraph is sometimes referred to herein for convenience as Refrigerant 5A

The present invention also includes refrigerants consisting essentially of:
(a) from 60% to 63% by weight of HFO-1234ze(E),
(b) from 9% to 10% by weight of HFC-134a; and
(c) from 27% to 30% of HFCO-1233zd(E).

The refrigerant according to this paragraph is sometimes referred to herein for convenience as Refrigerant 5B.

The present invention also includes refrigerants consisting essentially of:
(a) from 60% to 63% by weight of HFO-1234ze(E),
(b) from 9% to 10.5% by weight of HFC-134a; and
(c) from 27% to 30% of HFCO-1233zd(E),
   wherein said refrigerant is an A1 refrigerant and has a GWP of 150 or less.

The refrigerant according to this paragraph is sometimes referred to herein for convenience as Refrigerant 5C.

The present invention also includes refrigerants consisting of:
(a) 63%+0.3%/−2.0% by weight of HFO-1234ze(E),
(b) 10%+1.5%/−0.5% by weight of HFC-134a; and
(c) 27%+1.5%/−0.5% of HFCO-1233zd(E).

The refrigerant according to this paragraph is sometimes referred to herein for convenience as Refrigerant 6A.

The present invention also includes refrigerants consisting essentially of:
(a) from 61% to 64% by weight of HFO-1234ze(E),
(b) from 9% to 10% by weight of HFC-134a; and
(c) from 26% to 29% of HFCO-1233zd(E).

The refrigerant according to this paragraph is sometimes referred to herein for convenience as Refrigerant 6B.

The present invention also includes refrigerants consisting essentially of:
(d) from 61% to 64% by weight of HFO-1234ze(E),
(e) from 9% to 10.5% by weight of HFC-134a; and
(d) from 26% to 29% of HFCO-1233zd(E),
   wherein said refrigerant is an A1 refrigerant and has a GWP of 150 or less.

The refrigerant according to this paragraph is sometimes referred to herein for convenience as Refrigerant 6C.

The present invention also includes refrigerants consisting of:
(a) 58%+0.3%/−2.0% by weight of HFO-1234ze(E),
(b) 10%+1.5%/−0.5% by weight of HFC-134a; and
(c) 32%+1.5%/−0.5% of HFCO-1233zd(E).

The refrigerant according to this paragraph is sometimes referred to herein for convenience as Refrigerant 7A.

The present invention also includes refrigerants consisting essentially of:
(a) from 56% to 59% by weight of HFO-1234ze(E),
(b) from 9% to 10% by weight of HFC-134a; and
(c) from 31% to 34% of HFCO-1233zd(E).

The refrigerant according to this paragraph is sometimes referred to herein for convenience as Refrigerant 7B.

The present invention also includes refrigerants consisting essentially of:
(a) from 56% to 59% by weight of HFO-1234ze(E),
(b) from 9% to 10.5% by weight of HFC-134a; and
(c) from 31% to 34% of HFCO-1233zd(E),
   wherein said refrigerant is an A1 refrigerant and has a GWP of 150 or less.

The refrigerant according to this paragraph is sometimes referred to herein for convenience as Refrigerant 7C.

The present invention also includes refrigerants consisting of:
(a) 56%+0.3%/−2.0% by weight of HFO-1234ze(E),
(b) 10%+1.5%/−0.5% by weight of HFC-134a; and
(c) 34%+1.5%/−0.5% of HFCO-1233zd(E).

The refrigerant according to this paragraph is sometimes referred to herein for convenience as Refrigerant 8A.

The present invention also includes refrigerants consisting essentially of:
(a) from 54% to 57% by weight of HFO-1234ze(E),
(b) from 9% to 10% by weight of HFC-134a; and
(c) from 33% to 36% of HFCO-1233zd(E).

The refrigerant according to this paragraph is sometimes referred to herein for convenience as Refrigerant 8B.

The present invention also includes refrigerants consisting essentially of:
(d) from 54% to 57% by weight of HFO-1234ze(E),
(e) from 9% to 10.5% by weight of HFC-134a; and from 33% to 36% of HFCO-1233zd(E),
   wherein said refrigerant is an A1 refrigerant and has a GWP of 150 or less. The refrigerant according to this paragraph is sometimes referred to herein for convenience as Refrigerant 8C.

The present invention includes methods of providing heating and/or cooling comprising:
(a) providing a refrigeration system comprising a vapor compression refrigeration circuit comprising a compressor, a condenser, an evaporator and a refrigerant, wherein said refrigerant is any of Refrigerants 1-8;
(b) evaporating said refrigerant in said evaporator to provide cooling and/or condensing said refrigerant in said condenser to provide heating.

The method according to this paragraph is sometimes referred to herein for convenience as Heat Transfer Method 1.

The present invention includes methods of providing heating and/or cooling comprising:
(a) providing a refrigeration system comprising a vapor compression refrigeration circuit comprising a compressor, a condenser, an evaporator and a refrigerant, wherein said refrigerant is any of Refrigerants 1-8;
(b) evaporating said refrigerant in said evaporator to provide cooling or condensing said refrigerant in said condenser to provide heating, wherein said refrigerant has a COP in the system that is at least about 100% of the COP of R-134a in said system.

The method according to this paragraph is sometimes referred to herein for convenience as Heat Transfer Method 2.

The present invention includes methods of providing heating and/or cooling comprising:
(a) providing a refrigeration system comprising a vapor compression refrigeration circuit comprising a compressor, a condenser, an evaporator and a refrigerant, wherein said refrigerant is any of Refrigerants 1-8;
(b) evaporating said refrigerant in said evaporator to provide cooling or condensing said refrigerant in said condenser to provide heating, wherein said refrigerant has a COP in the system that is at least about 100% of the COP of R-404 in said system.

The method according to this paragraph is sometimes referred to herein for convenience as Heat Transfer Method 3.

The present invention includes heat transfer systems providing heating and/or cooling comprising:
(a) a vapor compression refrigeration circuit comprising a compressor, a condenser, an evaporator and a refrigerant, wherein said refrigerant is any of Refrigerants 1-8; and
(b) said refrigerant in said evaporator providing cooling and/or said refrigerant in said condenser providing heating.

The system according to this paragraph is sometimes referred to herein for convenience as Heat Transfer System 1.

The present invention includes heat transfer systems providing heating and/or cooling comprising:
(a) a vapor compression refrigeration circuit comprising a compressor, a condenser, an evaporator and a refrigerant, wherein said refrigerant is any of Refrigerants 1-8; and
(b) said refrigerant in said evaporator providing cooling and/or said refrigerant in said condenser providing heating, wherein said refrigerant has a COP in the system that is at least about 100% of the COP of R-134a in said system.

The system according to this paragraph is sometimes referred to herein for convenience as Heat Transfer System 2.

The present invention includes heat transfer systems providing heating and/or cooling comprising:
(a) a vapor compression refrigeration circuit comprising a compressor, a condenser, an evaporator and a refrigerant, wherein said refrigerant is any of Refrigerants 1-8; and
(b) said refrigerant in said evaporator providing cooling or said refrigerant in said condenser providing heating, wherein said refrigerant has a COP in the system that is at least about 100% of the COP of R-404A in said system.

The system according to this paragraph is sometimes referred to herein for convenience as Heat Transfer System 3.

The present invention includes cascade refrigeration systems, comprising:
(a) a low stage refrigeration circuit comprising a low stage refrigerant having a GWP of about 150 or less;
(b) an inter-circuit heat exchanger in which said low stage refrigerant condenses; and
(c) a high stage refrigeration circuit comprising a high stage refrigerant, wherein said high stage refrigerant is any of Refrigerants 1-8 and wherein said refrigerant evaporates in said inter-circuit heat exchanger at a temperature below said low stage refrigerant condensing temperature by absorbing heat from said refrigerant in said low stage refrigeration circuit.

For the purposes of convenience, systems in accordance with this paragraph are sometimes referred to herein as Cascade System 1A.

The present invention includes cascade refrigeration systems, comprising:
(a) a low stage refrigeration circuit comprising CO₂ as the low stage refrigerant;
(b) an inter-circuit heat exchanger in which said low stage refrigerant condenses; and
(c) a high stage refrigeration circuit comprising a high stage refrigerant, wherein said high stage refrigerant is any of Refrigerants 1-8 and wherein said refrigerant evaporates in said inter-circuit heat exchanger at a temperature below said low stage refrigerant condensing temperature by absorbing heat from said refrigerant in said low stage refrigeration circuit.

For the purposes of convenience, systems in accordance with this paragraph are sometimes referred to herein as Cascade System 1B.

The present invention includes cascade refrigeration systems, comprising:
(a) a low stage refrigeration circuit comprising HFO-1234yf as the low stage refrigerant;
(b) an inter-circuit heat exchanger in which said low stage refrigerant condenses; and
(c) a high stage refrigeration circuit comprising a high stage refrigerant, wherein said high stage refrigerant is any of Refrigerants 1-8 and wherein said refrigerant evaporates in said inter-circuit heat exchanger at a temperature below said low stage refrigerant condensing temperature by absorbing heat from said refrigerant in said low stage refrigeration circuit.

For the purposes of convenience, systems in accordance with this paragraph are sometimes referred to herein as Cascade System 1C.

The present invention includes cascade refrigeration systems, comprising:
(a) a low stage refrigeration circuit comprising R455A as the low stage refrigerant;
(b) an inter-circuit heat exchanger in which said low stage refrigerant condenses; and
(c) a high stage refrigeration circuit comprising a high stage refrigerant, wherein said high stage refrigerant is any of Refrigerants 1-8 and wherein said refrigerant evaporates in said inter-circuit heat exchanger at a temperature below said low stage refrigerant condensing temperature by absorbing heat from said refrigerant in said low stage refrigeration circuit.

For the purposes of convenience, systems in accordance with this paragraph are sometimes referred to herein as Cascade System 1D.

The present invention also includes methods for improving a heat transfer system containing or designed to contain R-134a or R404A, wherein said heat transfer system comprises or is designed to contain:
(i) an existing refrigerant having a GWP of greater than 150, such as R-134a or R404a, wherein said R-134a or R 404A refrigeration circuit comprises, in order of refrigerant flow, at least one evaporator located in or near a refrigerated space containing products accessible to consumers, at least one compressor, and at least one condenser, and at least one expansion device;
   wherein said method comprises:
(a) replacing said existing refrigerant with a replacement refrigerant comprising a refrigerant of the present invention, including each of Refrigerants 1-8; and
(b) optionally but preferably, making one or more changes to the system to increase the capacity thereof but without replacing said existing compressor.

### BRIEF DESCRIPTION OF THE FIGURES

FIG. 1A represents a schematic representation of an exemplary heat transfer system useful in low temperature refrigeration and medium temperature refrigeration.

FIG. 1B illustrates in schematic form a typical supermarket produce cooling case.

FIG. 2 represents in schematic from a typical cascade refrigeration system.

FIG. 3 is a schematic representation of an exemplary heat transfer system useful in low and medium temperature refrigeration and which includes an optional vapor injector.

FIG. 4 is a schematic representation of an exemplary heat transfer system useful in low and medium temperature refrigeration and which includes an optional liquid injector.

FIG. 5 is a schematic representation of an exemplary heat transfer system useful in low and medium temperature refrigeration and which includes an optional suction line/liquid line heat exchanger.

FIG. 6 is a schematic representation of an exemplary heat transfer system useful in low and medium temperature refrigeration and which includes an optional vapor injector and an oil separator.

FIG. 7 is a schematic representation of an exemplary air conditioning system using a pumped secondary circuit containing a refrigerant of the present invention.

FIG. 8 is a schematic representation of an exemplary air conditioning system using a pumped secondary circuit containing a refrigerant of the present invention and using a suction line liquid line heat exchanger in the primary circuit.

FIG. 9 is a schematic representation of an exemplary air conditioning system using a pumped secondary circuit containing a refrigerant of the present invention and using a suction line liquid line heat exchanger and a vapor injector in the primary circuit.

FIG. 10 is a schematic representation of an exemplary heat pump/air conditioning system using a pumped secondary circuit containing a refrigerant of the present invention and using reversing valves in the primary circuit and in the secondary circuit.

FIG. 11 is a schematic representation of an exemplary heat transfer system having a dedicated mechanical subcooling system (DMSS) as described in Example 18.

FIG. 12 is a schematic representation of an exemplary mini cascade refrigeration system as described in Example 9.

FIG. 13 is a schematic representation of an electronic cooling system for a precision data center cooling system, the performance of which is described in Example 16.

FIG. 14 is a schematic representation of a pumped two-phase cold plate cooling system for computer chip cooling in a data center, the performance of which is described in Example 17.

### DETAILED DESCRIPTION

### Definitions

As used herein, the terms “low stage” and “high stage” are used in a relative context to designate the relative evaporation temperatures of two or more cascaded refrigeration circuits. Thus, the term “low stage” in the context of a cascaded refrigeration system refers to the refrigeration circuit in which the refrigerant evaporators at temperature that is less than the evaporation temperature of the refrigerant in the “high stage.”

As used herein, the term “cascade refrigeration” refers to a refrigeration system having a low stage refrigerant vapor is cooled, and preferably condensed, at least in part by rejecting heat to the high stage refrigerant.

As used herein, the term “replacement” means the use of a composition of the present invention in a heat transfer system that had been designed for use with, or is suitable for use with, another refrigerant. By way of example, when a refrigerant or heat transfer composition of the present invention is used in a heat transfer system that was designed for use with R-134a, then the refrigerant or heat transfer composition of the present invention is a replacement for R-134a in said system. It will thus be understood that the term “replacement” includes the use of the refrigerants and heat transfer compositions of the present invention in both new and existing systems that had been designed for use with, or are suitable for use with, a designated refrigerant, such as R-134a or R404A.

The term “commercial refrigeration” refers to the cold storage equipment used in commercial settings, and includes commercial chillers used to keep items, such as food and beverages, below the average room temperature yet above freezing; commercial freezers used to keep perishable items frozen; and commercial chiller/freezer. Examples of commercial refrigeration include: the reach-in refrigerators and freezers found in supermarkets, specialty food stores, convenience stores, and grocery stores; walk-in freezers and refrigerators, including those found in restaurants, cafeterias and the like; plug-in enclosed vending machines, especially vending machines located in areas where restrictions in egress may be caused, such as hallways, corridors and the like; drop-in coolers; draft beer systems; undercounter refrigerators; and refrigerated display cases.

The phrase “coefficient of performance” (hereinafter sometimes “COP”) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration or cooling capacity to the energy applied by the compressor in compressing the vapor and therefore expresses the capability of a given compressor to pump quantities of heat for a given volumetric flow rate of a heat transfer fluid, such as a refrigerant. In other words, given a specific compressor, a refrigerant with a higher COP will deliver more cooling or heating power. One means for estimating COP of a refrigerant at specific operating conditions is from the thermodynamic properties of the refrigerant using standard refrigeration cycle analysis techniques (see for example, R. C. Downing, FLUOROCARBON REFRIGERANTS HANDBOOK, Chapter 3, Prentice-Hall, 1988 which is incorporated herein by reference in its entirety).

The phrase “Global Warming Potential” (hereinafter sometimes “GWP”) was developed to allow comparisons of the global warming impact of different gases. It compares the amount of heat trapped by a certain mass of a gas to the amount of heat trapped by a similar mass of carbon dioxide over a specific time period of time. Carbon dioxide was chosen by the Intergovernmental Panel on Climate Change (IPCC) as the reference gas and its GWP is taken as 1. The larger GWP, the more that a given gas warms the Earth compared to CO2 over that time period. As used herein, the term GWP means the value of GWP as measured in accordance with IPCC Fourth Assessment Report, referred to and abbreviated herein as AR4.

The term “non-flammable” refers to compounds or compositions which are determined to be nonflammable as determined in accordance with ASTM Standard E-681-2023 Standard Test Method for Concentration Limits of Flammability of Chemicals (Vapors and Gases) at conditions described in ASHRAE Standard 34-2022 Designation and Safety Classification of Refrigerants and described in Appendix B1 to ASHRAE Standard 34-2022 (as each standard exists as of the filing date of this application), which are incorporated herein by reference in its entirety (“Non-Flammability Test”). Flammability is defined as the ability of a composition to ignite and/or propagate a flame. Under this test, flammability is determined by measuring flame angles. A non-flammable substance would be classified as class “1” by ASHRAE Standard 34-2022 Designation and Safety Classification of Refrigerants test protocol defining conditions and apparatus and using the current method ASTM E681-09 annex A1 (as each standard exists as of the filing date of this application).

The term “Occupational Exposure Limit” (sometimes referred to as “OEL”) is determined in accordance with ASHRAE Standard 34-2022 Designation and Safety Classification of Refrigerants.

As used herein, the term “evaporator glide” means the difference between the inlet temperature of the refrigerant at the entrance to the evaporator and the saturation temperature of the refrigerant at the pressure of the evaporator, assuming the pressure at the evaporator exit is the same as the pressure at the inlet. As used herein, the phrase “saturation temperature” means the temperature at which the liquid refrigerant boils into vapor at a given pressure.

As used herein, the term “condenser glide” means the difference between the dew point temperature of the refrigerant and bubble point using condenser pressure, assuming the pressure at the condenser exit is the same as the pressure at the inlet.

The phrase “acceptable toxicity” as used herein means the composition is classified as class “A” by ASHRAE Standard 34-2022 Designation and Safety Classification of Refrigerants and described in Appendix B1 to ASHRAE Standard 34-2022 (as each standard exists as of the filing date of this application). A substance which is non-flammable and acceptable toxicity would be classified as “A1” by ASHRAE Standard 34-2022 Designation and Safety Classification of Refrigerants and described in Appendix B1 to ASHRAE Standard 34-2022 (as each standard exists as of the filing date of this application).

The term “degree of superheat” or simply “superheat” means the temperature rise of the refrigerant at the exit of the evaporator above the saturated vapor temperature (or dew temperature) of the refrigerant.

As used herein, the term “E-1,3,3,3-tetrafluoropropene” means the trans isomer of HFO-1234ze and is abbreviated as HFO-1234ze(E).

As used herein, the term “E-1-chloro-3,3,3-trifluoropropene” means the trans isomer of HFCO-1233zd and is abbreviated as HFCO-1233zd(E).

As used herein, the term “low temperature refrigeration” refers to a refrigeration system that operates under or within the following conditions: (a) condenser temperature from about 15° C. to about 50° C.; and (b) evaporator temperature from about −40° C. to about or less than about −15° C.

As used herein, the term “medium temperature refrigeration” refers to a refrigeration system that utilizes one or more compressors and operates under or within the following conditions: (a) a condenser temperature of from about 15° C. to about 60° C.; and (b) evaporator temperature of from about −15° C. to about 5° C.

As used herein the term “high temperature heat pump system” means a vapor compression system operable in a heating mode in which the condensing temperature of the refrigerant is from about 55° C. to about 95° C.

As used herein the term “centralized refrigeration system” means a refrigeration system that includes one or more centrally located compressors or rack of compressors and one or more centrally located condensers, and a plurality of evaporators located remotely from said centralized compressor or rack of compressors and which receive liquid refrigerant from said centrally located condenser(s). As used herein, the terms “HFC-125” and “R125” mean pentafluoroethane.

As used herein, the terms “HFC-134a” and “R134a” mean 1,1,1,2-tetrafluoroethane.

As used herein, the term “R143a” means 1,1,1-trifluoroethane.

As used herein, the term “R404A” means a combination of about 44% by weight of R-125, about 52% by weight of R143a and about 4% by weight of R-134a.

As used herein, the term “R455A” means the refrigerant designated by ASHRAE as 455A and which consists of 21.5%+2/−1% of R-32, 75.5 of HFC-1234yf+2/−2% and 3%+2/−1% of CO₂.

As used herein, the term “R454C” means the refrigerant designated by ASHRAE as 454C and which consists of 21.5%+2/−1% of R-32, 78.5 of HFC-1234yf+2/−2%.

As used herein, the term “about” in relation to the amount expressed in weight percent means that the amount of the component can vary by an amount of about 10 relative percent of the stated among. Thus, for the purpose of clarity, the term “about 10% by weight” means from 9% to 11% by weight.

As used herein, reference to a group of compositions, methods, and the like, defined by numbers, specifically includes all such numbered compositions, including all numbered compositions with a suffix. For example, the reference to “any of Refrigerants 1-8” includes each of Refrigerant 1A, Refrigerant 1B, Refrigerant 1C, Refrigerant 2A, Refrigerant 2B, Refrigerant 2C, etc.

### Refrigerants and Heat Transfer Compositions:

Applicants have found that the refrigerants of the present invention, including each of Refrigerants 1-8 as described herein, are unexpectedly capable of providing a set of exceptionally advantageous properties including: excellent heat transfer properties (including high COP and/or capacity relative to HFC-134a and/or R404A), acceptable toxicity and nonflammability (i.e., is Class A1), zero or near zero ozone depletion potential (“ODP”), relatively low evaporator and/or condenser glide, and lubricant compatibility, including miscibility with POE and/or PVE lubricants over the operating temperature and concentration ranges used in medium and low temperature refrigeration systems, cascade refrigeration systems, transport refrigeration systems, air conditioning systems and heat pump systems.

A particular advantage of the preferred refrigerants of the present invention, including specifically each of Refrigerants 1-8, is that they are nonflammable or mildly flammable and have acceptable toxicity, that is, each is a Class A1 refrigerant. It will be appreciated by the skilled person that the flammability of a refrigerant can be a characteristic that is given consideration in certain important heat transfer applications, and that refrigerants that are classified as Class A1 can frequently be an advantage over refrigerants that are not Class A1. Thus, it is a desire in the art to provide a refrigerant composition which can be used as a replacement for prior non-flammable refrigerants, such as R-22, R404A, R407F, R448A, R449A, R-134a. R404A and R410A 410A which has excellent heat transfer properties, acceptable toxicity, zero or near zero ODP, and lubricant compatibility, including miscibility with POE and/or PVE lubricants over the operating temperature and concentration ranges used in medium and low temperature refrigeration systems, cascade refrigeration systems, air conditioning systems, transport refrigeration systems, and heat pumps (including residential air-to-water heat pump systems), and which maintains non-flammability or mild flammability in use. This desirable advantage can be achieved by the refrigerants of the present invention.

Applicants have found that the refrigerant compositions of the invention, including each of Refrigerants 1-8, are capable of achieving a difficult-to-achieve combination of properties including particularly low GWP. Thus, the compositions of the invention have a GWP of 150 or less.

In addition, the refrigerant compositions of the invention, including each of Refrigerants 1-8, have a zero or near zero ODP. Thus, the compositions of the invention have an ODP of not greater than 0.02, and preferably zero.

In addition, the refrigerant compositions of the invention, including each of Refrigerants 1-8, show acceptable toxicity and preferably have an OEL of greater than about 400. As those skilled in the art are aware, a non-flammable refrigerant that has an OEL of greater than about 400 is advantageous since it results in the refrigerant being classified in the desirable Class A of ASHRAE standard 34.

The preferred refrigerant compositions of the invention show both acceptable toxicity and nonflammability under ASHRAE standard 34 and are therefore Class A1 refrigerants. Applicants have found that the heat transfer compositions of the present invention, including heat transfer compositions that include each of Refrigerants 1-8 as described herein, are capable of providing an exceptionally advantageous and unexpected combination of properties including: good heat transfer properties, chemical stability under the conditions of use, acceptable toxicity, nonflammability or mild flammability, zero or near zero ozone depletion potential (“ODP”), and lubricant compatibility, including miscibility with POE and/or PVE lubricants over the operating temperature and concentration ranges used in medium and low temperature refrigeration systems, cascade refrigeration systems, air conditioning systems, transport refrigeration systems, and heat pumps (including residential air-to-water heat pump systems).

The heat transfer compositions can consist essentially of any refrigerant of the present invention, including each of Refrigerants 1-8.

The refrigerants of the invention may be provided in a heat transfer composition. Thus, the heat transfer compositions of the present invention comprise a refrigerant of the present invention, including any of the preferred refrigerant compositions disclosed herein and in particular each of Refrigerants 1-8. Preferably, the invention relates to a heat transfer composition which comprises the refrigerant, including each of Refrigerants 1-8, in an amount of at least about 80% by weight of the heat transfer composition, or at least about 90% by weight of the heat transfer composition, or at least about 97% by weight of the heat transfer composition, or at least about 99% by weight of the heat transfer composition. The heat transfer composition may consist essentially of or consist of the refrigerant.

The heat transfer compositions of the present invention can consist of any refrigerant of the present invention, including each of Refrigerants 1-8.

The heat transfer compositions of the invention may include other components for the purpose of enhancing or providing certain functionality to the compositions. Such other components may include, in addition to the refrigerant of the present invention, including each of Refrigerants 1-8, one or more of lubricants, passivators, flammability suppressants, dyes, solubilizing agents, compatibilizers, stabilizers, antioxidants, corrosion inhibitors, extreme pressure additives and anti-wear additives and other compounds and/or components that modulate a particular property of the heat transfer composition, and the presence of all such compounds and components is within the broad scope of the invention.

### Lubricants

The heat transfer compositions of the invention can comprise a refrigerant as described herein, including each of Refrigerants 1-8, and a lubricant. Heat transfer compositions as described in this paragraph are sometimes referred to for convenience as Heat Transfer Composition 1.

The heat transfer compositions of the invention can also comprise a refrigerant as described herein, including each of Refrigerants 1-8, and a polyol ester (POE) lubricant. Heat transfer compositions as described in this paragraph are sometimes referred to for convenience as Heat Transfer Composition 2.

The heat transfer compositions of the invention can also comprise a refrigerant as described herein, including each of Refrigerants 1-8, and a poly vinyl ether (PVE) lubricant. Heat transfer compositions as described in this paragraph are sometimes referred to for convenience as Heat Transfer Composition 3.

The heat transfer compositions of the invention can also comprise a refrigerant as described herein, including each of Refrigerants 1-8, and a polyol alkylene glycol (PAG) lubricant. Heat transfer compositions as described in this paragraph are sometimes referred to for convenience as Heat Transfer Composition 4.

Applicants have found that the heat transfer compositions of the present invention, including each of Heat Transfer Compositions 1-8 are capable of providing exceptionally advantageous properties including, in addition to the advantageous properties identified herein with respect to the refrigerant, excellent refrigerant/lubricant compatibility, including miscibility with POE and/or PVE and/or PAG lubricants, over the operating temperature and concentration ranges used in stationary air conditioning systems (including residential air conditioning, commercial air conditioning, VRF air conditioning), chillers (including air cooled chillers), heat pump systems (including residential air-to-water heat pump systems), and commercial refrigeration (including medium temperature refrigeration and low temperature refrigeration).

A lubricant consisting essentially of a POE having a viscosity at 40° C. measured in accordance with ASTM D445 of from about 30 to about 70 is referred to herein as Lubricant 1.

Commercially available POEs that are preferred for use in the present heat transfer compositions include neopentyl glycol dipelargonate which is available as Emery 2917 (registered trademark) and Hatcol 2370 (registered trademark) and pentaerythritol derivatives including those sold under the trade designations Emkarate RL32-3MAF and Emkarate RL68H by CPI Fluid Engineering. Emkarate RL32-3MAF and Emkarate RL68H are preferred POE lubricants having the properties identified below:

| Property | RL32-3MAF | RL68H |
|---|---|---|
| Viscosity @ | about 31 | about 67 |
| 40° C. (ASTM | | |
| D445), cSt | | |
| Viscosity @ | about 5.6 | about 9.4 |
| 100° C. (ASTM | | |
| D445), cSt | | |
| Pour Point | about −40 | about −40 |
| (ASTM D97), ° C. | | |

A preferred heat transfer composition comprises a refrigerant of the present invention, including each of Refrigerants 1-8 and Lubricant 1. Heat transfer compositions as described in this paragraph are sometimes referred to for convenience as Heat Transfer Composition 5.

A lubricant consisting essentially of a POE having a viscosity at 40° C. measured in accordance with ASTM D445 of from about 30 to about 70 based on the weight of the heat transfer composition, is referred to herein as Lubricant 2.

Commercially available polyvinyl ethers that are preferred for use in the present heat transfer compositions that have a viscosity at 40° C. measured in accordance with ASTM D445 of from about 30 to about 70 include those lubricants sold under the trade designations FVC32D and FVC68D, from Idemitsu.

A preferred heat transfer composition comprises a refrigerant of the present invention, including each of Refrigerants 1-8 and Lubricant 2. Heat transfer compositions as described in this paragraph are sometimes referred to for convenience as Heat Transfer Composition 6.

The invention comprises includes heat transfer compositions of the present invention, including each of Heat Transfer Compositions 1-8, wherein the lubricant is present in the heat transfer composition in an amount of from about 0.1% by weight to about 5% by weight of the heat transfer composition. Heat transfer compositions as described in this paragraph are sometimes referred to for convenience as Heat Transfer Composition 7.

The invention comprises includes heat transfer compositions of the present invention, including each of Heat Transfer Compositions 1-8, wherein the lubricant is present in the heat transfer composition in an amount of from about 0.1% by weight to about 2% by weight of the heat transfer composition. Heat transfer compositions as described in this paragraph are sometimes referred to for convenience as Heat Transfer Composition 8.

The invention comprises includes heat transfer compositions of the present invention, including each of Heat Transfer Compositions 1-8, wherein the lubricant is present in the heat transfer composition in an amount of from about 0.1% by weight to about 1% by weight of the heat transfer composition. Heat transfer compositions as described in this paragraph are sometimes referred to for convenience as Heat Transfer Composition 9.

The invention comprises includes heat transfer compositions of the present invention, including each of Heat Transfer Compositions 1-8, wherein the lubricant is present in the heat transfer composition in an amount of from about 0.1% by weight to about 0.5% by weight of the heat transfer composition. Heat transfer compositions as described in this paragraph are sometimes referred to for convenience as Heat Transfer Composition 10.

The invention comprises includes heat transfer compositions of the present invention, including each of Heat Transfer Compositions 1-11, wherein the lubricant is present in the heat transfer composition in an amount of from about 0.2% by weight to about 0.5% by weight of the heat transfer composition. Heat transfer compositions as described in this paragraph are sometimes referred to for convenience as Heat Transfer Composition 11.

Other additives not mentioned herein can also be included by those skilled in the art in view of the teaching contained herein without departing from the novel and basic features of the present invention.

Combinations of surfactants and solubilizing agents may also be added to the present compositions to aid oil solubility as disclosed in U.S. Pat. No. 6,516,837, the disclosure of which is incorporated by reference in its entirety.

### Methods, Uses and Systems

### Systems

The present invention includes heat transfer systems of all types that include refrigerants of the present invention that include heat transfer compositions of the invention, including each of Heat Transfer Compositions 1-11. Heat transfer systems as described in this paragraph are sometimes referred to for convenience as Heat Transfer System 4.

The present invention also includes, and provides particular advantage in connection with, low temperature refrigeration systems that include refrigerants of the present invention, including each of Refrigerants 1-8. Heat transfer systems as described in this paragraph are sometimes referred to for convenience as Heat Transfer System 5A.

The present invention also includes, and provides particular advantage in connection with, low temperature refrigeration systems that heat transfer compositions of the invention, including each of Heat Transfer Compositions 1-11. Heat transfer systems as described in this paragraph are sometimes referred to for convenience as Heat Transfer System 5B.

The present invention also includes, and provides particular advantage in connection with, medium temperature refrigeration systems that include refrigerants of the present invention, including each of Refrigerants 1-8. Heat transfer systems as described in this paragraph are sometimes referred to for convenience as Heat Transfer System 6A.

The present invention also includes, and provides particular advantage in connection with, medium temperature refrigeration systems that include heat transfer compositions of the invention, including each of Heat Transfer Compositions 1-11. Heat transfer systems as described in this paragraph are sometimes referred to for convenience as Heat Transfer System 6B.

The present invention also includes, and provides particular advantage in connection with, air conditioning systems that include refrigerants of the present invention, including each of Refrigerants 1-8. Heat transfer systems as described in this paragraph are sometimes referred to for convenience as Heat Transfer System 8A.

The present invention also includes, and provides particular advantage in connection with, air conditioning systems that include heat transfer compositions of the present invention, including each of Heat Transfer Compositions 1-11. Heat transfer systems as described in this paragraph are sometimes referred to for convenience as Heat Transfer System 8B.

The present invention also includes, and provides particular advantage in connection with, heat pump systems that include refrigerants of the present invention, including each of Refrigerants 1-8. Heat transfer systems as described in this paragraph are sometimes referred to for convenience as Heat Transfer System 9A.

The present invention also includes, and provides particular advantage in connection with, heat pump systems that include heat transfer compositions of the invention, including each of Heat Transfer Compositions 1-11. Heat transfer systems as described in this paragraph are sometimes referred to for convenience as Heat Transfer System 9B.

The present invention also includes and provides particular advantage in connection with cascade refrigeration systems that include refrigerants of the present invention, including each of Refrigerants 1-8. Heat transfer systems as described in this paragraph are sometimes referred to for convenience as Heat Transfer System 10A.

The present invention also includes and provides particular advantage in connection with cascade refrigeration systems that include heat transfer compositions of the invention, including each of Heat Transfer Compositions 1-11. Heat transfer systems as described in this paragraph are sometimes referred to for convenience as Heat Transfer System 10B.

The present invention also includes, and provides particular advantage in connection with, commercial refrigeration (including low temperature commercial refrigeration and medium temperature commercial refrigeration) that include refrigerants of the present invention, including each of Refrigerants 1-8. Heat transfer systems as described in this paragraph are sometimes referred to for convenience as Heat Transfer System 11A.

The present invention also includes, and provides particular advantage in connection with, commercial refrigeration (including low temperature commercial refrigeration and medium temperature commercial refrigeration) that include heat transfer compositions of the invention, including each of Heat Transfer Compositions 1-11. Heat transfer systems as described in this paragraph are sometimes referred to for convenience as Heat Transfer System 11B.

For heat transfer systems of the present invention that include a compressor and lubricant for the compressor in the system, the system can comprise a loading of refrigerant of the present invention, including each of Refrigerants 1-8, and lubricant, including POE and PVE lubricant, such that the lubricant loading in the system is from about 5% to 60% by weight, or from about 10% to about 60% by weight, or from about 20% to about 50% by weight, or from about 20% to about 40% by weight, or from about 20% to about 30% by weight, or from about 30% to about 50% by weight, or from about 30% to about 40% by weight. As used herein, the term “lubricant loading” refers to the total weight of lubricant contained in the system as a percentage of total of lubricant and refrigerant contained in the system. Such systems may also include a lubricant loading of from about 5% to about 10% by weight, or about 8% by weight of the heat transfer composition.

In particular aspects, heat transfer compositions of the invention comprise any one of Refrigerants 1 to 8 and lubricant in a low temperature refrigeration system as follows:

| | | REFRIGERATION |
|---|---|---|
| REFRIGERANT | LUBRICANT | SYSTEM |
| Refrigerant 1 | POE or | low temperature |
| | PVE | refrigeration |
| Refrigerant 2 | POE or | low temperature |
| | PVE | refrigeration |
| Refrigerant 3 | POE or | low temperature |
| | PVE | refrigeration |
| Refrigerant 4 | POE or | low temperature |
| | PVE | refrigeration |
| Refrigerant 5 | POE or | low temperature |
| | PVE | refrigeration |
| Refrigerant 6 | POE or | low temperature |
| | PVE | refrigeration |
| Refrigerant 7 | POE or | low temperature |
| | PVE | refrigeration |
| Refrigerant 8 | POE or | low temperature |
| | PVE | refrigeration |

Heat transfer compositions comprise any one of Refrigerants 1 to 8 and lubricant in a medium temperature refrigeration system as follows:

| REFRIGERANT | LUBRICANT | REFRIGERATION SYSTEM |
|---|---|---|
| Refrigerant 1 | POE or | medium temperature |
| | PVE | refrigeration |
| Refrigerant 2 | POE or | medium temperature |
| | PVE | refrigeration |
| Refrigerant 3 | POE or | medium temperature |
| | PVE | refrigeration |
| Refrigerant 4 | POE or | medium temperature |
| | PVE | refrigeration |
| Refrigerant 5 | POE or | medium temperature |
| | PVE | refrigeration |
| Refrigerant 6 | POE or | medium temperature |
| | PVE | refrigeration |
| Refrigerant 7 | POE or | medium temperature |
| | PVE | refrigeration |
| Refrigerant 8 | POE or | medium temperature |
| | PVE | refrigeration |

Heat transfer compositions comprise any one of Refrigerants 1 to 8 and lubricant in a medium temperature refrigeration system with a two or more stage compressor as follows:

| REFRIGERANT | LUBRICANT | REFRIGERATION SYSTEM |
|---|---|---|
| Refrigerant 1 | POE or | medium temperature |
| | PVE | refrigeration |
| | | with multi-stage |
| | | compression |
| Refrigerant 2 | POE or | medium temperature |
| | PVE | refrigeration |
| | | with multi-stage |
| | | compression |
| Refrigerant 3 | POE or | medium temperature |
| | PVE | refrigeration |
| | | with multi-stage |
| | | compression |
| Refrigerant 4 | POE or | medium temperature |
| | PVE | refrigeration |
| | | with multi-stage |
| | | compression |
| Refrigerant 5 | POE or | medium temperature |
| | PVE | refrigeration |
| | | with multi-stage |
| | | compression |
| Refrigerant 6 | POE or | medium temperature |
| | PVE | refrigeration |
| | | with multi-stage |
| | | compression |
| Refrigerant 7 | POE or | medium temperature |
| | PVE | refrigeration |
| | | with multi-stage |
| | | compression |
| Refrigerant 8 | POE or | medium temperature |
| | PVE | refrigeration |
| | | with multi-stage |
| | | compression |

Heat transfer compositions comprise any one of Refrigerants 1 to 8 and lubricant in a medium temperature refrigeration system with a two or more stage compressor and vapor injection as follows:

| REFRIGERANT | LUBRICANT | REFRIGERATION SYSTEM |
|---|---|---|
| Refrigerant 1 | POE or | medium temperature |
| | PVE | refrigeration |
| | | with multi-stage |
| | | compression and |
| | | vapor injection |
| Refrigerant 2 | POE or | medium temperature |
| | PVE | refrigeration |
| | | with multi-stage |
| | | compression and |
| | | vapor injection |
| Refrigerant 3 | POE or | medium temperature |
| | PVE | refrigeration |
| | | with multi-stage |
| | | compression and |
| | | vapor injection |
| Refrigerant 4 | POE or | medium temperature |
| | PVE | refrigeration |
| | | with multi-stage |
| | | compression and |
| | | vapor injection |
| Refrigerant 5 | POE or | medium temperature |
| | PVE | refrigeration |
| | | with multi-stage |
| | | compression and |
| | | vapor injection |
| Refrigerant 6 | POE or | medium temperature |
| | PVE | refrigeration |
| | | with multi-stage |
| | | compression and |
| | | vapor injection |
| Refrigerant 7 | POE or | medium temperature |
| | PVE | refrigeration |
| | | with multi-stage |
| | | compression and |
| | | vapor injection |
| Refrigerant 8 | POE or | medium temperature |
| | PVE | refrigeration |
| | | with multi-stage |
| | | compression and |
| | | vapor injection |

Heat transfer compositions comprise any one of Refrigerants 1 to 8 and lubricant in a medium temperature refrigeration system with a dedicated mechanical subcooling system as follows:

| REFRIGERANT | LUBRICANT | REFRIGERATION SYSTEM |
|---|---|---|
| Refrigerant 1 | POE or | medium temperature |
| | PVE | refrigeration |
| | | with dedicated |
| | | mechanical subcooling |
| Refrigerant 2 | POE or | medium temperature |
| | PVE | refrigeration |
| | | with dedicated |
| | | mechanical subcooling |
| Refrigerant 3 | POE or | medium temperature |
| | PVE | refrigeration |
| | | with dedicated |
| | | mechanical subcooling |
| Refrigerant 4 | POE or | medium temperature |
| | PVE | refrigeration |
| | | with dedicated |
| | | mechanical subcooling |
| Refrigerant 5 | POE or | medium temperature |
| | PVE | refrigeration |
| | | with dedicated |
| | | mechanical subcooling |
| Refrigerant 6 | POE or | medium temperature |
| | PVE | refrigeration |
| | | with dedicated |
| | | mechanical subcooling |
| Refrigerant 7 | POE or | medium temperature |
| | PVE | refrigeration |
| | | with dedicated |
| | | mechanical subcooling |
| Refrigerant 8 | POE or | medium temperature |
| | PVE | refrigeration |
| | | with dedicated |
| | | mechanical subcooling |

Heat transfer compositions comprise any one of Refrigerants 1 to 8 and lubricant in a retail food refrigeration system as follows:

| | | REFRIGERATION |
|---|---|---|
| REFRIGERANT | LUBRICANT | SYSTEM |
| Refrigerant 1 | POE or | Retail food |
| | PVE | refrigeration |
| Refrigerant 2 | POE or | Retail food |
| | PVE | refrigeration |
| Refrigerant 3 | POE or | Retail food |
| | PVE | refrigeration |
| Refrigerant 4 | POE or | Retail food |
| | PVE | refrigeration |
| Refrigerant 5 | POE or | Retail food |
| | PVE | refrigeration |
| Refrigerant 6 | POE or | Retail food |
| | PVE | refrigeration |
| Refrigerant 7 | POE or | Retail food |
| | PVE | refrigeration |
| Refrigerant 8 | POE or | Retail food |
| | PVE | refrigeration |

Heat transfer compositions comprise any one of Refrigerants 1 to 8 and lubricant in a vending machine system as follows:

| | | REFRIGERATION |
|---|---|---|
| REFRIGERANT | LUBRICANT | SYSTEM |
| Refrigerant 1 | POE or | Vending machine |
| | PVE | |
| Refrigerant 2 | POE or | Vending machine |
| | PVE | |
| Refrigerant 3 | POE or | Vending machine |
| | PVE | |
| Refrigerant 4 | POE or | Vending machine |
| | PVE | |
| Refrigerant 5 | POE or | Vending machine |
| | PVE | |
| Refrigerant 6 | POE or | Vending machine |
| | PVE | |
| Refrigerant 7 | POE or | Vending machine |
| | PVE | |
| Refrigerant 8 | POE or | Vending machine |
| | PVE | |

Heat transfer compositions comprise any one of Refrigerants 1 to 8 and lubricant in a transport refrigeration system as follows:

| REFRIGERANT | LUBRICANT | REFRIGERATION SYSTEM |
|---|---|---|
| Refrigerant 1 | POE or | Transport refrigeration |
| | PVE | |
| Refrigerant 2 | POE or | Transport refrigeration |
| | PVE | |
| Refrigerant 3 | POE or | Transport refrigeration |
| | PVE | |
| Refrigerant 4 | POE or | Transport refrigeration |
| | PVE | |
| Refrigerant 5 | POE or | Transport refrigeration |
| | PVE | |
| Refrigerant 6 | POE or | Transport refrigeration |
| | PVE | |
| Refrigerant 7 | POE or | Transport refrigeration |
| | PVE | |
| Refrigerant 8 | POE or | Transport refrigeration |
| | PVE | |

Heat transfer compositions comprise any one of Refrigerants 1 to 8 and lubricant in a medium temperature transport refrigeration system as follows:

| REFRIGERANT | LUBRICANT | REFRIGERATION SYSTEM |
|---|---|---|
| Refrigerant 1 | POE or | Medium Temperature |
| | PVE | Transport |
| | | refrigeration |
| Refrigerant 2 | POE or | Medium Temperature |
| | PVE | Transport |
| | | refrigeration |
| Refrigerant 3 | POE or | Medium Temperature |
| | PVE | Transport |
| | | refrigeration |
| Refrigerant 4 | POE or | Medium Temperature |
| | PVE | Transport |
| | | refrigeration |
| Refrigerant 5 | POE or | Medium Temperature |
| | PVE | Transport |
| | | refrigeration |
| Refrigerant 6 | POE or | Medium Temperature |
| | PVE | Transport |
| | | refrigeration |
| Refrigerant 7 | POE or | Medium Temperature |
| | PVE | Transport |
| | | refrigeration |
| Refrigerant 8 | POE or | Medium Temperature |
| | PVE | Transport |
| | | refrigeration |

Heat transfer compositions comprise any one of Refrigerants 1 to 8 and lubricant in a medium temperature transport refrigeration system as follows:

| REFRIGERANT | LUBRICANT | REFRIGERATION SYSTEM |
|---|---|---|
| Refrigerant 1 | POE or | Low Temperature |
| | PVE | Transport |
| | | refrigeration |
| Refrigerant 2 | POE or | Low Temperature |
| | PVE | Transport |
| | | refrigeration |
| Refrigerant 3 | POE or | Low Temperature |
| | PVE | Transport |
| | | refrigeration |
| Refrigerant 4 | POE or | Low Temperature |
| | PVE | Transport |
| | | refrigeration |
| Refrigerant 5 | POE or | Low Temperature |
| | PVE | Transport |
| | | refrigeration |
| Refrigerant 6 | POE or | Low Temperature |
| | PVE | Transport |
| | | refrigeration |
| Refrigerant 7 | POE or | Low Temperature |
| | PVE | Transport |
| | | refrigeration |
| Refrigerant 8 | POE or | Low Temperature |
| | PVE | Transport |
| | | refrigeration |

Heat transfer compositions comprise any one of Refrigerants 1 to 8 and lubricant in a cascade refrigeration system as follows:

| REFRIGERANT | LUBRICANT | REFRIGERATION SYSTEM |
|---|---|---|
| Refrigerant 1 | POE or | Cascade refrigeration |
| | PVE | |
| Refrigerant 2 | POE or | Cascade refrigeration |
| | PVE | |
| Refrigerant 3 | POE or | Cascade refrigeration |
| | PVE | |
| Refrigerant 4 | POE or | Cascade refrigeration |
| | PVE | |
| Refrigerant 5 | POE or | Cascade refrigeration |
| | PVE | |
| Refrigerant 6 | POE or | Cascade refrigeration |
| | PVE | |
| Refrigerant 7 | POE or | Cascade refrigeration |
| | PVE | |
| Refrigerant 8 | POE or | Cascade refrigeration |
| | PVE | |

Heat transfer compositions comprise any one of Refrigerants 1 to 8 and lubricant in a micro cascade refrigeration system as follows:

| REFRIGERANT | LUBRICANT | REFRIGERATION SYSTEM |
|---|---|---|
| Refrigerant 1 | POE or | Micro Cascade |
| | PVE | refrigeration |
| Refrigerant 2 | POE or | Micro Cascade |
| | PVE | refrigeration |
| Refrigerant 3 | POE or | Micro Cascade |
| | PVE | refrigeration |
| Refrigerant 4 | POE or | Micro Cascade |
| | PVE | refrigeration |
| Refrigerant 5 | POE or | Micro Cascade |
| | PVE | refrigeration |
| Refrigerant 6 | POE or | Micro Cascade |
| | PVE | refrigeration |
| Refrigerant 7 | POE or | Micro Cascade |
| | PVE | refrigeration |
| Refrigerant 8 | POE or | Micro Cascade |
| | PVE | refrigeration |

Heat transfer compositions comprise any one of Refrigerants 1 to 8 and lubricant in an air conditioning system as follows:

| REFRIGERANT | LUBRICANT | REFRIGERATION SYSTEM |
|---|---|---|
| Refrigerant 1 | PAG | Air Conditioning |
| Refrigerant 2 | PAG | Air Conditioning |
| Refrigerant 3 | PAG | Air Conditioning |
| Refrigerant 4 | PAG | Air Conditioning |
| Refrigerant 5 | PAG | Air Conditioning |
| Refrigerant 6 | PAG | Air Conditioning |
| Refrigerant 7 | PAG | Air Conditioning |
| Refrigerant 8 | PAG | Air Conditioning |

Heat transfer compositions comprise any one of Refrigerants 1 to 8 and lubricant in a mobile air conditioning system as follows:

| REFRIGERANT | LUBRICANT | REFRIGERATION SYSTEM |
|---|---|---|
| Refrigerant 1 | PAG | Mobile Air Conditioning |
| Refrigerant 2 | PAG | Mobile Air Conditioning |
| Refrigerant 3 | PAG | Mobile Air Conditioning |
| Refrigerant 4 | PAG | Mobile Air Conditioning |
| Refrigerant 5 | PAG | Mobile Air Conditioning |
| Refrigerant 6 | PAG | Mobile Air Conditioning |
| Refrigerant 7 | PAG | Mobile Air Conditioning |
| Refrigerant 8 | PAG | Mobile Air Conditioning |

Heat transfer compositions comprise any one of Refrigerants 1 to 8 and lubricant in a stationary air conditioning system as follows:

| REFRIGERANT | LUBRICANT | REFRIGERATION SYSTEM |
|---|---|---|
| Refrigerant 1 | PAG | Stationary Air Conditioning |
| Refrigerant 2 | PAG | Stationary Air Conditioning |
| Refrigerant 3 | PAG | Stationary Air Conditioning |
| Refrigerant 4 | PAG | Stationary Air Conditioning |
| Refrigerant 5 | PAG | Stationary Air Conditioning |
| Refrigerant 6 | PAG | Stationary Air Conditioning |
| Refrigerant 7 | PAG | Stationary Air Conditioning |
| Refrigerant 8 | PAG | Stationary Air Conditioning |

Heat transfer compositions comprise any one of Refrigerants 1 to 8 and lubricant in a stationary air conditioning system as follows:

| REFRIGERANT | LUBRICANT | REFRIGERATION SYSTEM |
|---|---|---|
| Refrigerant 1 | PAG | Commercial Air Conditioning |
| Refrigerant 2 | PAG | Commercial Air Conditioning |
| Refrigerant 3 | PAG | Commercial Air Conditioning |
| Refrigerant 4 | PAG | Commercial Air Conditioning |
| Refrigerant 5 | PAG | Commercial Air Conditioning |
| Refrigerant 6 | PAG | Commercial Air Conditioning |
| Refrigerant 7 | PAG | Commercial Air Conditioning |
| Refrigerant 8 | PAG | Commercial Air Conditioning |

Heat transfer compositions comprise any one of Refrigerants 1 to 8 and lubricant in a vending machine with an SLLL heat exchanger as follows:

| REFRIGERANT | LUBRICANT | REFRIGERATION SYSTEM |
|---|---|---|
| Refrigerant 1 | POE or PVE | Vending Machine with SL-LL HX |
| Refrigerant 2 | POE or PVE | Vending Machine with SL-LL HX |
| Refrigerant 3 | POE or PVE | Vending Machine with SL-LL HX |
| Refrigerant 4 | POE or PVE | Vending Machine with SL-LL HX |
| Refrigerant 5 | POE or PVE | Vending Machine with SL-LL HX |
| Refrigerant 6 | POE or PVE | Vending Machine with SL-LL HX |
| Refrigerant 7 | POE or PVE | Vending Machine with SL-LL HX |
| Refrigerant 8 | POE or PVE | Vending Machine with SL-LL HX |

Heat transfer compositions comprise any one of Refrigerants 1 to 8 and lubricant in a heat pump as follows:

| REFRIGERANT | LUBRICANT | REFRIGERATION SYSTEM |
|---|---|---|
| Refrigerant 1 | PAG | Heat Pump |
| Refrigerant 2 | PAG | Heat Pump |
| Refrigerant 3 | PAG | Heat Pump |
| Refrigerant 4 | PAG | Heat Pump |
| Refrigerant 5 | PAG | Heat Pump |
| Refrigerant 6 | PAG | Heat Pump |
| Refrigerant 7 | PAG | Heat Pump |
| Refrigerant 8 | PAG | Heat Pump |

Heat transfer compositions comprise any one of Refrigerants 1 to 8 and lubricant in an air-source heat pump water heater as follows:

| REFRIGERANT | LUBRICANT | REFRIGERATION SYSTEM |
|---|---|---|
| Refrigerant 1 | PAG | Air Source Heat Pump Water Heater |
| Refrigerant 2 | PAG | Air Source Heat Pump Water Heater |
| Refrigerant 3 | PAG | Air Source Heat Pump Water Heater |
| Refrigerant 4 | PAG | Air Source Heat Pump Water Heater |
| Refrigerant 5 | PAG | Air Source Heat Pump Water Heater |
| Refrigerant 6 | PAG | Air Source Heat Pump Water Heater |
| Refrigerant 7 | PAG | Air Source Heat Pump Water Heater |
| Refrigerant 8 | PAG | Air Source Heat Pump Water Heater |

Heat transfer compositions comprise any one of Refrigerants 1 to 8 and lubricant in a high temperature heat pump as follows:

| REFRIGERANT | LUBRICANT | REFRIGERATION SYSTEM |
|---|---|---|
| Refrigerant 1 | PAG | High Temperature Heat Pump |
| Refrigerant 2 | PAG | High Temperature Heat Pump |
| Refrigerant 3 | PAG | High Temperature Heat Pump |
| Refrigerant 4 | PAG | High Temperature Heat Pump |
| Refrigerant 5 | PAG | High Temperature Heat Pump |
| Refrigerant 6 | PAG | High Temperature Heat Pump |
| Refrigerant 7 | PAG | High Temperature Heat Pump |
| Refrigerant 8 | PAG | High Temperature Heat Pump |

Heat transfer compositions comprise any one of Refrigerants 1 to 8 and lubricant in a vapor compression cooling system used for heat transfer in electronics system:

| REFRIGERANT | LUBRICANT | REFRIGERATION SYSTEM |
|---|---|---|
| Refrigerant 1 | PAG | Electronics Cooling Vapor Compressor System |
| Refrigerant 2 | PAG | Electronics Cooling Vapor Compressor System |
| Refrigerant 3 | PAG | Electronics Cooling Vapor Compressor System |
| Refrigerant 4 | PAG | Electronics Cooling Vapor Compressor System |
| Refrigerant 5 | PAG | Electronics Cooling Vapor Compressor System |
| Refrigerant 6 | PAG | Electronics Cooling Vapor Compressor System |
| Refrigerant 7 | PAG | Electronics Cooling Vapor Compressor System |
| Refrigerant 8 | PAG | Electronics Cooling Vapor Compressor System |

### Exemplary Heat Transfer Systems

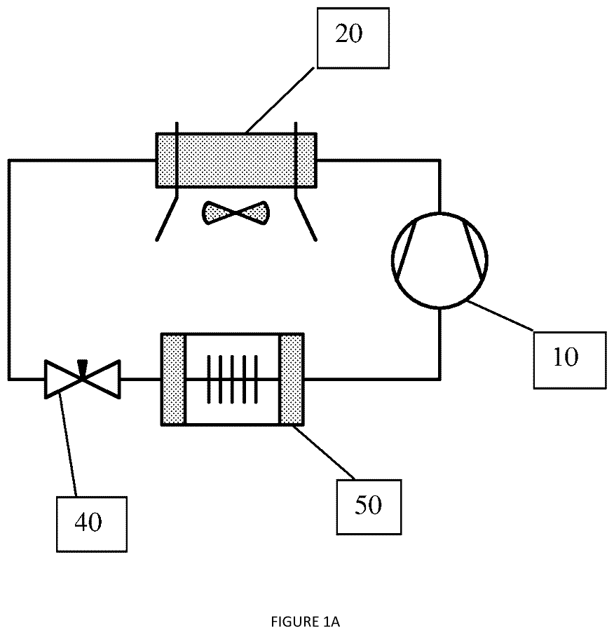

As described in detail below, the preferred systems of the present invention comprise a compressor, a condenser, an expansion device and an evaporator, all connected in fluid communication using piping, valving and control systems such that the refrigerant and associated components of the heat transfer composition can flow through the system in known fashion to complete the refrigeration cycle. An exemplary schematic of such a basic system is illustrated in FIG. 1A. In particular, the system schematically illustrated in FIG. 1A shows a compressor 10, which provides compressed refrigerant vapor to condenser 20. The compressed refrigerant vapor is condensed to produce a liquid refrigerant which is then directed to an expansion device 40 that produces refrigerant at reduced temperature pressure, which in turn is then provided to evaporator 50. In evaporator 50 the liquid refrigerant absorbs heat from the body or fluid being cooled, thus producing a refrigerant vapor which is then provided to the suction line of the compressor.

The refrigeration system illustrated in FIG. 1B represents a typical supermarket produce cooling case. Typically, as illustrated in FIG. 1B, cooled, moisture-bearing air is provided to the product display zone of the display case by passing air, both from outside of the case 102 and from recirculating air 104, over the heat exchange surface of an evaporator coil 106 disposed within the display case in a region which typically separate from (or as least hidden from the view of customer) but near to the product display zone. The evaporator 106 has a single component refrigerant inlet 108 and a single component refrigerant outlet 110. A circulating fan 114 is also used. It is highly desirable in systems of the type illustrated above that the cooled space 112 in the refrigeration system has a refrigerant temperature along the evaporator that always or substantially always is above a certain level.

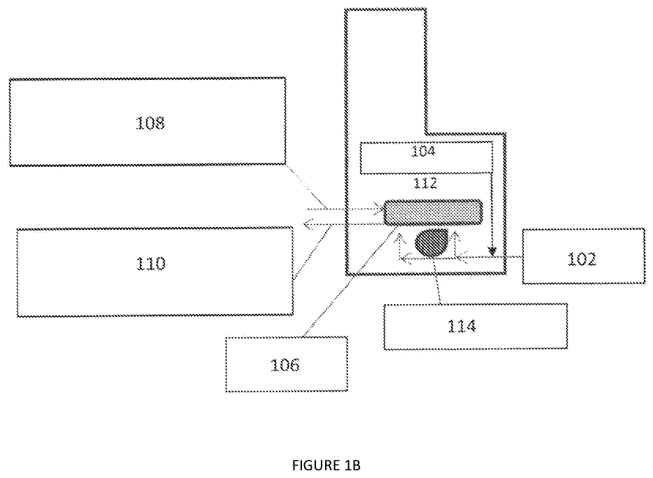

The refrigeration system illustrated in FIG. 2 is the same as described above in connection with FIG. 1A except that it includes a cascade refrigeration system. The medium temperature refrigeration circuit 110 provides both the medium temperature cooling and removes the rejected heat from the lower temperature refrigeration circuit 120 via a heat exchanger 130. The medium temperature refrigeration circuit 110 extends between a roof 140, a machine room 141 and a sales floor 142. The low temperature refrigeration circuit 120 extends between the machine room 141 and the sales floor 142.

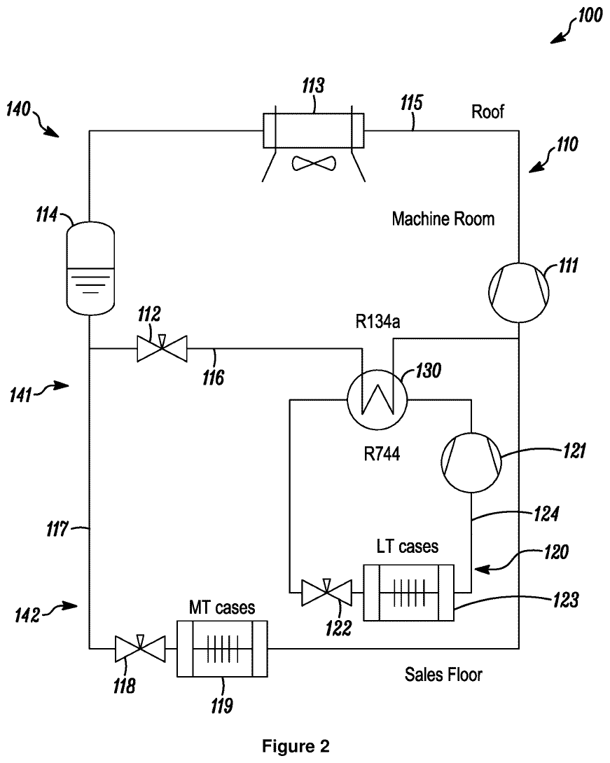

The refrigeration system illustrated in FIG. 3 is the same as described above in connection with FIG. 1A except that it includes a vapor injection system including heat exchanger 30 and bypass expansion valve 25. The bypass expansion device 25 diverts a portion of the refrigerant flow at the condenser outlet through the device and thereby provides liquid refrigerant to heat exchanger 30 at a reduced pressure, and hence at a lower temperature, to heat exchanger 30. This relatively cool liquid refrigerant then exchanges heat with the remaining, relatively high temperature liquid from the condenser. This operation produces a subcooled liquid to the main expansion device 40 and evaporator 50 and returns a relatively cool refrigerant vapor to the compressor 10. In this way the injection of the cooled refrigerant vapor into the suction side of the compressor serves to maintain compressor discharge temperatures in acceptable limits, which can be especially advantageous in low temperature systems that utilize high compression ratios.

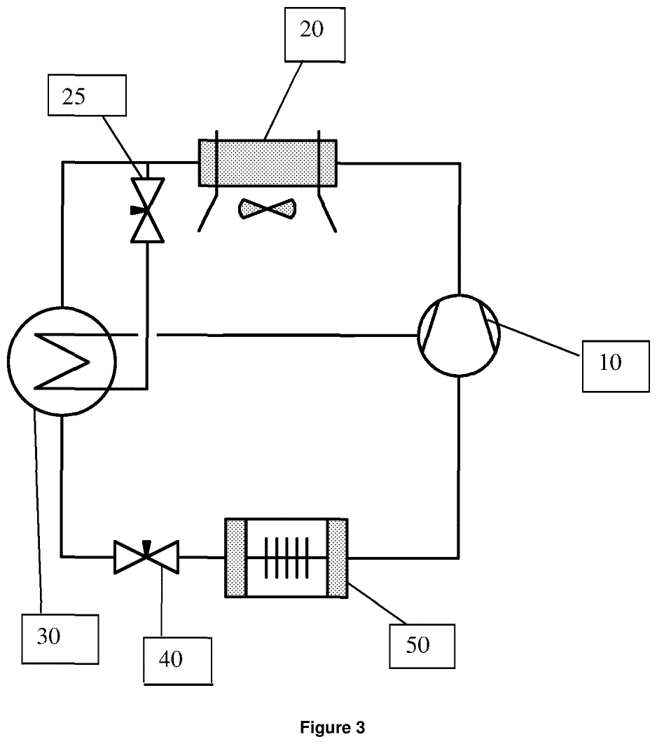

The refrigeration system illustrated in FIG. 4 is the same as described above in connection with FIG. 1A except that it includes a liquid injection system including bypass valve 26. The bypass valve 26 diverts a portion of the liquid refrigerant exiting the condenser to the compressor, preferably to a liquid injection port in the compressor 10. In this way the injection of liquid refrigerant into the suction side of the compressor serves to maintain compressor discharge temperatures in acceptable limits, which can be especially advantageous in low temperature systems that utilize high compression ratios.

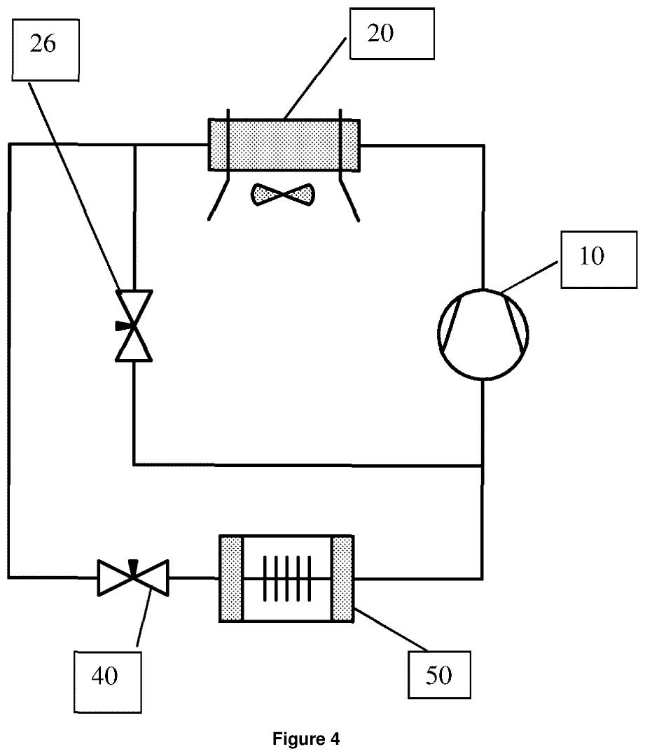

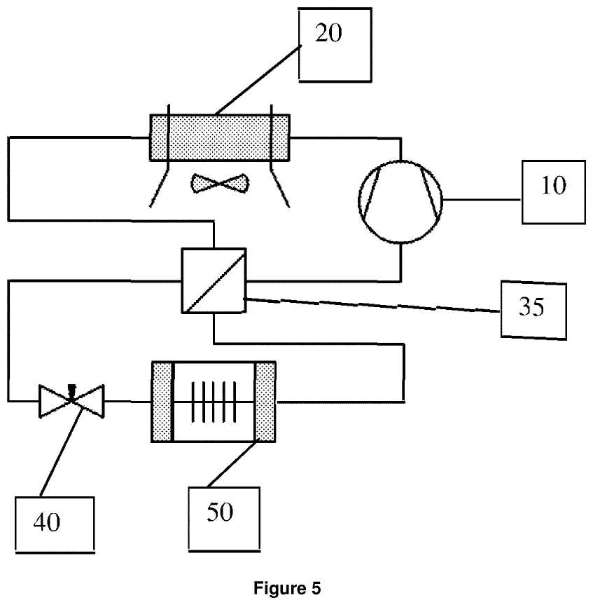

The refrigeration system illustrated in FIG. 5 is the same as described above in connection with FIG. 1A except that it includes a liquid line/suction line heat exchanger 35. The refrigerant flow at the condenser outlet is directed to the liquid line/suction line heat exchanger 35, where heat is transferred from the liquid refrigerant to the refrigerant vapor leaving evaporator 50 prior to being introduced to compressor 10.

It will be appreciated by those skilled in the art that the different equipment/configuration options shown separately in each of FIGS. 2-5 can be combined and used together as deemed advantageous for any application.

### Uses

### General Uses

The methods and systems of the present invention may comprise any heat transfer system and/or any heat transfer method which utilize a refrigerant, including each of Refrigerants 1-8, or a heat transfer composition comprising a refrigerant of the present invention, including each of Heat Transfer Compositions 1-11, to either absorb heat, or reject heat or both absorb and reject heat. Thus, the present invention provides uses and methods of heating or cooling a fluid or body using a refrigerant, including each of Refrigerants 1-8, or a heat transfer composition comprising a refrigerant of the present invention, including each of Heat Transfer Compositions 1-11.

The present invention also includes and provides particular advantage in connection with use of the refrigerants of the present invention, including each of Refrigerants 1-8, and/or heat transfer compositions that include Refrigerants 1 to 8, including each of Heat Transfer Compositions 1-11, in medium temperature refrigeration systems.

The present invention also includes and provides particular advantage in connection with use of the refrigerants of the present invention, including each of Refrigerants 1-8, and/or heat transfer compositions that include Refrigerants 1 to 8, including each of Heat Transfer Compositions 1-11, in low temperature refrigeration systems.

The present invention also includes and provides particular advantage in connection with use of the refrigerants of the present invention, including each of Refrigerants 1-8, and/or heat transfer compositions that include Refrigerants 1 to 8, including each of Heat Transfer Compositions 1-11, in air conditioning systems.

The present invention also includes and provides particular advantage in connection with use of the refrigerants of the present invention, including each of Refrigerants 1-8, and/or heat transfer compositions that include Refrigerants 1 to 8, including each of Heat Transfer Compositions 1-11, in transport refrigeration systems.

The present invention also includes and provides particular advantage in connection with use of the refrigerants of the present invention, including each of Refrigerants 1-8, and/or heat transfer compositions that include Refrigerants 1 to 8, including each of Heat Transfer Compositions 1-11, in a cascade refrigeration system.

The present invention also includes, and provides particular advantage in connection with use of the refrigerants of the present invention, including each of Refrigerants 1-8, and/or heat transfer compositions that include Refrigerants 1 to 8, including each of Heat Transfer Compositions 1-11, as the refrigerant in the high side of a cascade refrigeration system.

The present invention also includes and provides particular advantage in connection with use of the refrigerants of the present invention, including each of Refrigerants 1-8, and/or heat transfer compositions that include Refrigerants 1 to 8, including each of Heat Transfer Compositions 1-11, in vending machines.

The present invention also includes and provides particular advantage in connection with use of the refrigerants of the present invention, including each of Refrigerants 1-8, and/or heat transfer compositions that include Refrigerants 1 to 8, including each of Heat Transfer Compositions 1-11, in stationary air conditioning.

The present invention also includes and provides particular advantage in connection with use of the refrigerants of the present invention, including each of Refrigerants 1-8, and/or heat transfer compositions that include Refrigerants 1 to 8, including each of Heat Transfer Compositions 1-11, in commercial air conditioning.

The present invention also includes and provides particular advantage in connection with use of the refrigerants of the present invention, including each of Refrigerants 1-8, and/or heat transfer compositions that include Refrigerants 1 to 8, including each of Heat Transfer Compositions 1-1, in heat pump systems.

### Replacement Uses

The present invention also includes and provides particular advantage in connection with use of the refrigerants of the present invention, including each of Refrigerants 1-8, and/or heat transfer compositions that include Refrigerants 1 to 8, including each of Heat Transfer Compositions 1-11, as a replacement for R-134a.

The present invention also includes and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-404A.

### Refrigeration, Air Conditioning and Heat Pump Methods

The present invention also provides a method for cooling a fluid or body using a refrigeration system wherein the method comprises the steps of (a) evaporating a refrigerant composition of the invention, including each of Refrigerants 1-8, and/or heat transfer compositions that include Refrigerants 1 to 8, including each of Heat Transfer Compositions 1-11, in the vicinity of the fluid or body to be cooled, and (b) condensing the refrigerant. The particular and preferred operation of preferred heat transfer methods are described below.

### Medium Temperature Refrigeration Methods

The refrigerant and heat transfer compositions of the invention can be used in any refrigeration system. However, Applicants have found that the present refrigerants, including each of Refrigerants 1-8, and the present heat transfer compositions comprising a refrigerant of the present invention, including each of Heat Transfer Compositions 1-11, provide a particular advantage in medium temperature refrigeration systems. Thus, the present invention provides a method of cooling a fluid or body in a medium temperature refrigeration system, the method comprising the steps of (a) evaporating a refrigerant composition of the invention, including each of Refrigerants 1-8, or heat transfer composition comprising a refrigerant of the present invention, including each of Heat Transfer Composition 1-11, in the vicinity of the fluid or body to be cooled, and (b) condensing the refrigerant, wherein the evaporator temperature is from about −15° C. to about 5° C., more preferably from about −10° C. to about 5° C.

A medium temperature refrigeration system as used herein refers to a refrigeration system that utilizes one or more compressors (including single stage and multiple stage compressors) and operates under or within the following conditions: (a) a condenser temperature of from about 15° C. to about 60° C., preferably from about 25° C. to about 45° C.; (b) evaporator temperature of from about −15° C. to about 5° C., preferably from about −10° C. to about 5° C.; optionally (c) a degree of superheat at evaporator outlet of from about 0° C. to about 10° C., preferably with a degree of superheat at evaporator outlet of from about 1° C. to about 6° C.; and optionally (d) a degree of superheat in the suction line of from about 5° C. to about 40° C., preferably with a degree of superheat in the suction line of from about 15° C. to about 30° C. The superheat along the suction line may also be generated by a heat exchanger.

Examples of medium temperature refrigeration systems and medium temperature refrigeration methods include small refrigeration systems (including vending machines, ice machines, and appliances), commercial refrigeration systems (such as supermarket refrigeration systems and walk-in coolers), residential refrigeration systems, industrial refrigeration systems, and ice rinks.

Therefore, the invention includes medium temperature refrigeration methods comprising a refrigerant, including each of Refrigerants 1-8, or heat transfer composition comprising a refrigerant of the present invention, including each of Heat Transfer Compositions 1-11 wherein the evaporator temperature of refrigerant is from about 0° C. to about 5° C.

### Cascade Refrigeration Methods

The present invention also includes cascade refrigeration methods comprising a refrigerant or heat transfer composition of the invention. Generally, a cascade system has two or more stages, as illustrated for Example in FIG. 2 hereof. When a cascade system has two stages, these are generally referred to as the upper stage and the lower stage. The refrigerant of the invention, including each of Refrigerants 1-8, or heat transfer compositions comprising a refrigerant of the present invention, including each of Heat Transfer Compositions 1-11 may be used in either the upper or lower stage of a cascade refrigeration system. However, it is preferred that the refrigerant of the invention, including each of Refrigerants 1-8, or a heat transfer composition comprising a refrigerant of the present invention, including each of Heat Transfer Compositions 1-11, is used in the upper stage of a cascade system. In view of the teachings contained herein, a person skilled in the art will be able to determine suitable refrigerants for use in the lower stage of the cascade system, and include for example CO2, R1234yf, and R455A. In cascade systems, the present refrigerants may replace, for example, R404A.

### Centralized Refrigeration Systems

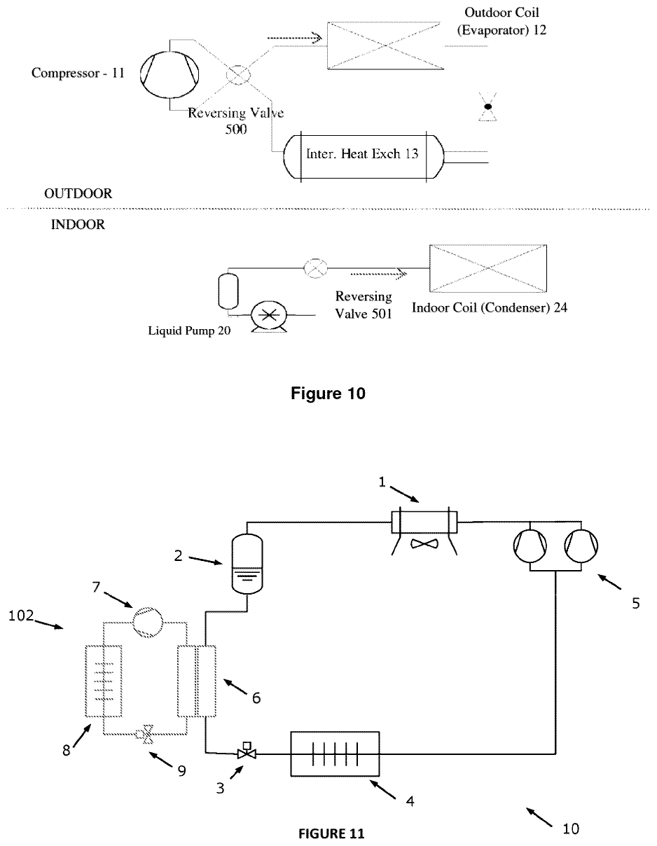

FIG. 2 also illustrates a centralized refrigeration system in which one or more compressors 111 (preferably a rack of compressors) and one or more condensers 113 is located in a machine room located remotely from public access and which feeds cold refrigerant to one or more (preferably and usually a plurality of cases located in an area which are available to consumers (such as a MT cases 119). A preferred aspect of the present invention relates to the use of a refrigerant of the present invention, including each of Refrigerants 1-8, or heat transfer compositions comprising a refrigerant of the present invention, including each of Heat Transfer Compositions 1-11, to replace the refrigerant circulating to the plurality of cases receiving cold refrigerant from the condensers in the machine room. In such replacement methods, it is often preferred that the central compressors are not replaced, but other less substantial modifications are made to improve the capacity of the system. One example of such changes is to add a dedicated mechanical subcooling system (DMSS) as described in Example 18 and illustrated in FIG. 11. Another example of such changes is to add doors to the plurality of cooling cases (such as MT cooling cases 119) so that the capacity demand of the system is lower. For the replacement methods as described in this paragraph, the present refrigerants, including each of Refrigerants 1-8, or heat transfer compositions comprising a refrigerant of the present invention, including each of Heat Transfer Compositions 1-11, can replace R404A. For the replacement methods as described in this paragraph, the present refrigerants, including each of Refrigerants 1-8, or heat transfer compositions comprising a refrigerant of the present invention, including each of Heat Transfer Compositions 1-11, can replace R134A.

### Low Temperature Refrigeration Methods

The present invention also provides low temperature refrigeration methods comprising a refrigerant, including each of Refrigerants 1-8, or heat transfer composition comprising a refrigerant of the present invention, including each of Heat Transfer Compositions 1-11. The present invention also provides a method of cooling a fluid or body in a low temperature refrigeration system, said method comprising the steps of (a) evaporating a refrigerant composition of the invention, including each of Refrigerants 1-8, in the vicinity of the fluid or body to be cooled, and (b) condensing said refrigerant. Preferably the temperature of the refrigerant in the evaporator is from about −40° C. to less than about −15° C., more preferably from about −40° C. to about −25° C.

A low temperature refrigeration system as used herein to refers to a refrigeration system that utilizes one or more compressors and operates under or within the following conditions: (a) condenser temperature from about 15° C. to about 50° C., preferably of from about 25° C. to about 45° C.; (b) evaporator temperature from about-40° C. to about or less than about −15° C., preferably from about −40° C. to about −25° C.; optionally (c) a degree of superheat at evaporator outlet of from about 0° C. to about 10° C., preferably of from about 1° C. to about 6° C.; and optionally (d) a degree of superheat in the suction line of from about 15° C. to about 40° C., preferably of from about 20° C. to about 30° C.

Examples of low temperature refrigeration systems and methods include supermarket refrigeration systems, commercial freezer systems (including supermarket freezers), residential freezer systems, and industrial freezer systems. The low temperature refrigeration system may be used, for example, to cool frozen goods.

### Transport Refrigeration Methods

Transport refrigeration creates the link in the cold chain allowing frozen or chilled produce to reach the end user in the correct temperature environment. The present invention relates to a transport refrigeration system comprising a refrigerant of the invention, including each of Refrigerants 1-8, or heat transfer composition comprising a refrigerant of the present invention, including each of Heat Transfer Compositions 1-11. Examples of transport refrigeration include refrigerated road vehicles (such as trucks and vans), train railcars, and containers capable of being transported by road vehicles, trains, and ships/boats.

### Heat Pump Methods

The present invention relates to a heat pump method comprising a refrigerant of the invention, including each of Refrigerants 1-8, or a heat transfer composition comprising a refrigerant of the present invention, including each of Heat Transfer Compositions 1-11.

The present invention also provides a method of heating a fluid or body using a heat pump, the method comprising the steps of (a) condensing a refrigerant composition of the invention, including each of Refrigerants 1-8 or a heat transfer composition comprising a refrigerant of the present invention, including each of Heat Transfer Compositions 1-11, in the vicinity of the fluid or body to be heated, and (b) evaporating the refrigerant. Examples of heat pumps include heat pump tumble driers, reversible heat pumps, high temperature heat pumps, and air-to-air heat pumps.

### Secondary Loop Methods

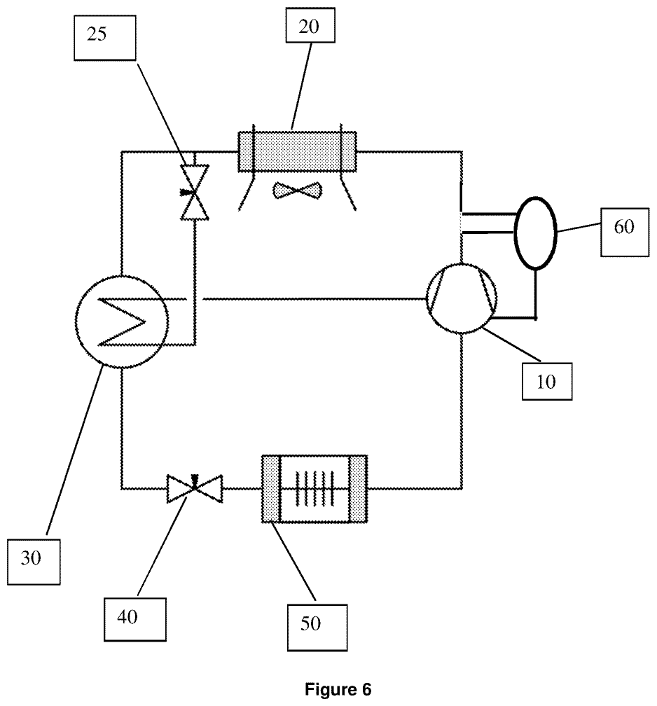

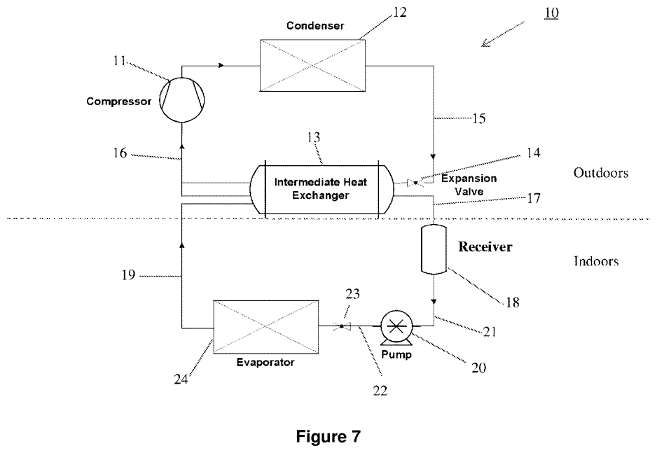

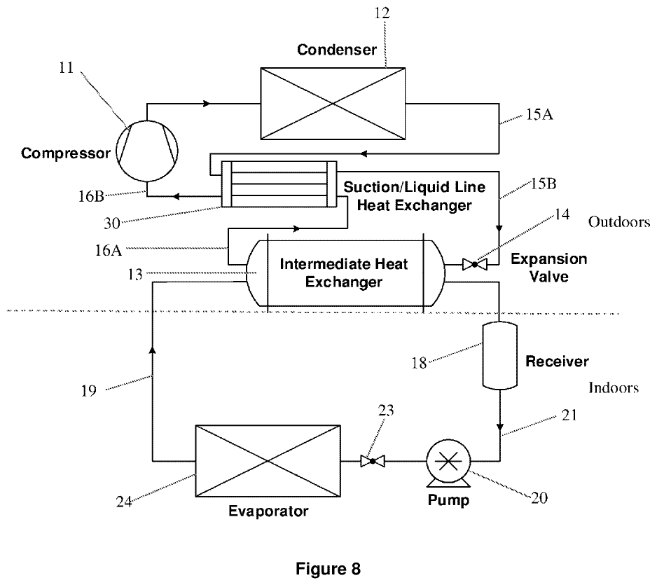

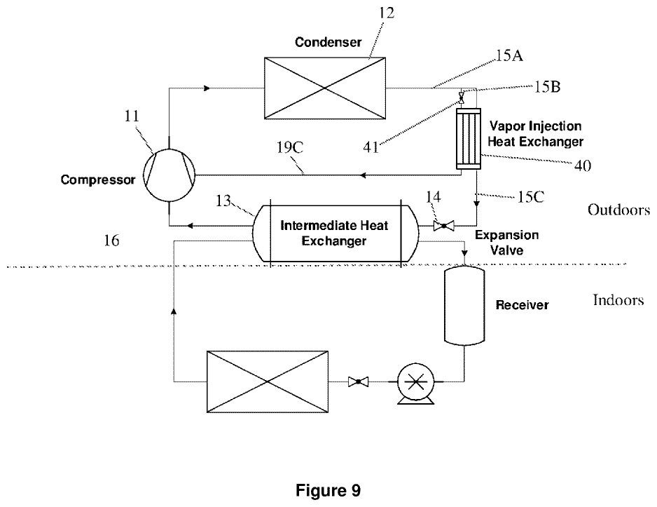

The refrigerant of the present invention, including each of Refrigerants 1-8, or heat transfer composition comprising a refrigerant of the present invention, including each of Heat Transfer Compositions 1-11, may be used as secondary fluid in a secondary loop system. Examples of secondary loop systems are shown, for example in FIGS. 7-10. A secondary loop system contains a primary vapor compression system loop that uses a primary refrigerant and has an evaporator that cools the secondary loop fluid. The secondary fluid then provides the necessary cooling for an application. The secondary fluid must be non-flammable or at least mildly flammable and have low toxicity since the refrigerant in such a loop is potentially exposed to humans in the vicinity of the cooled space. In other words, the refrigerant of the present invention, including each of Refrigerants 1-8, or a heat transfer composition comprising a refrigerant of the present invention, including each of Heat Transfer Compositions 1-11, may be used as a “secondary fluid”. A preferred aspect of the present invention relates to the use of a refrigerant of the present invention, including each of Refrigerants 1-8, or heat transfer compositions comprising a refrigerant of the present invention, including each of Heat Transfer Compositions 1-11, to replace the secondary refrigerant in a secondary loop system. In such replacement methods, it is often preferred that the compressor(s) in the primary loop are not replaced, but other less substantial modifications are made to improve the capacity of the system. One example of such changes is to add a dedicated mechanical subcooling system (DMSS) as described in Example 18 and illustrated in FIG. 11 to the secondary loop. Another example of such changes is to add doors to the cooling case(s) in which the evaporator is contained so that the capacity demand of the system is lower. For the replacement methods as described in this paragraph, the present refrigerants, including each of Refrigerants 1-8, or heat transfer compositions comprising a refrigerant of the present invention, including each of Heat Transfer Compositions 1-11, can replace R404A. For the replacement methods as described in this paragraph, the present refrigerants, including each of Refrigerants 1-8, or heat transfer compositions comprising a refrigerant of the present invention, including each of Heat Transfer Compositions 1-11, can replace R134A.

A primary fluid for use in the primary loop (vapor compression cycle, external/outdoors part of the loop) may include the following refrigerants but not limited to R404A, R507, R410A, R455A, R32, R466A, R44B, R290, R717, R452B, R448A, R1234ze(E), R1234yf, and R449A.

### Air Conditioning Methods

The present invention relates to an air conditioning system comprising a refrigerant of the invention, including each of Refrigerants 1-8, or heat transfer composition comprising a refrigerant of the present invention, including each of Heat Transfer Compositions 1-11. The present invention also provides a method of air conditioning using an air conditioning system, said method comprising the steps of (a) evaporating a refrigerant composition of the invention, including each of Refrigerants 1-8, in the vicinity of a fluid of body to be cooled, and (b) condensing said refrigerant. Air may be conditioned either directly or indirectly by the refrigerants of the invention, including each of Refrigerants 1-8 or a heat transfer composition comprising a refrigerant of the present invention, including each of Heat Transfer Compositions 1-11. Examples of air conditioning systems include chillers, residential, industrial, commercial, and mobile air-conditioning including air conditioning of road vehicles such as automobiles, trucks and buses, as well as air conditioning of boats, and trains.

Preferred refrigeration systems of the present invention include chillers comprising a refrigerant of the present invention, including particularly each of Refrigerants 1-8, or a heat transfer composition comprising a refrigerant of the present invention, including each of Heat Transfer Compositions 1-11.

Preferred refrigeration systems of the present invention include stationary air-conditioning systems comprising a refrigerant of the present invention, including particularly each of Refrigerants 1-8, or a heat transfer composition comprising a refrigerant of the present invention, including each of Heat Transfer Compositions 1-11.

Preferred refrigeration systems of the present invention include commercial air-conditioning systems comprising a refrigerant of the present invention, including particularly each of Refrigerants 1-8, or a heat transfer composition comprising a refrigerant of the present invention, including each of Heat Transfer Compositions 1-11.

Preferred refrigeration systems of the present invention include vending machines comprising a refrigerant of the present invention, including particularly each of Refrigerants 1-8, or a heat transfer composition comprising a refrigerant of the present invention, including each of Heat Transfer Compositions 1-11.

Preferred refrigeration systems of the present invention include walk-in freezers comprising a refrigerant of the present invention, including particularly each of Refrigerants 1-8, or a heat transfer composition comprising a refrigerant of the present invention, including each of Heat Transfer Compositions 1-11.

Preferred refrigeration systems of the present invention include walk-in refrigerators comprising a refrigerant of the present invention, including particularly each of Refrigerants 1-8, or a heat transfer composition comprising a refrigerant of the present invention, including each of Heat Transfer Compositions 1-11.

It will be appreciated that any of the above refrigeration, air conditioning or heat pump systems using the refrigerant of the invention, including each of Refrigerants 1-8, or heat transfer compositions comprising a refrigerant of the present invention, including each of Heat Transfer Compositions 1-11, may comprise a suction line/liquid line heat exchanger (SL-LL HX).

It will be appreciated that any of the above refrigeration, air conditioning or heat pump systems using the refrigerant of the invention, including each of Refrigerants 1-8, or heat transfer compositions comprising a refrigerant of the present invention, including each of Heat Transfer Compositions 1-11, may comprise a vapor injector.

### Electronics Cooling

The present invention relates to electronics cooling systems comprising a refrigerant of the invention, including each of Refrigerants 1-8, or heat transfer composition comprising a refrigerant of the present invention, including each of Heat Transfer Compositions 1-11. The present invention also provides a method of electronics cooling comprising the steps of (a) evaporating a refrigerant composition of the invention, including each of Refrigerants 1-8, by absorbing heat from an operating electronics component or system and (b) condensing said refrigerant.

The present invention relates to electronics cooling systems comprising a refrigerant of the invention, including each of Refrigerants 1-8, or heat transfer composition comprising a refrigerant of the present invention, including each of Heat Transfer Compositions 1-11. The present invention also provides a method of electronics cooling comprising the steps of (a) evaporating a refrigerant composition of the invention, including each of Refrigerants 1-8, by absorbing heat from an operating electronics component or system to produce a refrigerant vapor and (b) condensing said refrigerant vapor by transferring heat from said refrigerant vapor to a heat sink.

### EXAMPLES

In the Examples which follow, the refrigerant compositions of the present invention are identified as compositions R1-R6 in Table 1 below. Each of the refrigerants was subjected to thermodynamic analysis to determine its ability to match the operating characteristics of R-134a or R404A in various refrigeration systems. The analysis was performed using experimental data collected for properties of various binary and ternary pairs of components used in the refrigerant. The composition of each pair was varied over a series of relative percentages in the experimental evaluation and the mixture parameters for each pair were regressed to the experimentally obtained data. Known vapor/liquid equilibrium behavior data available in the National Institute of Science and Technology (NIST) Reference Fluid Thermodynamic and Transport Properties Database software (Refprop 9.1 NIST Standard Database 23 from April 2016) was used for the Examples. The parameters selected for conducting the analysis were: same compressor displacement for all refrigerants, same operating conditions for all refrigerants, same compressor isentropic and volumetric efficiency for all refrigerants. In each Example, simulations were conducted using the measured vapor liquid equilibrium data. The simulation results are reported for each Example, together with the result of flammability testing for refrigerant R1. Based on applicant's test work and the test results for R1, and although flammability is not predictable, applicant believes that R2-R6 are likely either A1 or A2L.

TABLE 1
Refrigerants evaluated for Performance Examples

| | R1234ze(E) | R1233zd(E) | R134a | | |
|---|---|---|---|---|---|
| Refrigerant | (wt %) | (wt %) | (wt %) | GWP | Class |
| R1 | 60% | 30% | 10% | 148 | A1 |
| R2 | 60% | 31% | 9% | 134 | A1 or |
| | | | | | A2L |
| R3 | 62% | 28% | 10% | 148 | A1 or |
| | | | | | A2L |
| R4 | 63% | 27% | 10% | 148 | A1 or |
| | | | | | A2L |
| R5 | 58% | 32% | 10% | 148 | A1 or |
| | | | | | A2L |
| R6 | 56% | 34% | 10% | 148 | A1 or |
| | | | | | A2L |

For the purposes of comparison, two refrigerant blends (designated C1 and C2 below) are outside of the scope of the preferred refrigerants of the present invention and were also tested/evaluated with respect to GWP. Each refrigerant was based on a combination of HFO-1234ze(E), HFO-1233zd (E) and HFC-134a (1,1,1,2-tetrafluoroethane), and the results of the testing/evaluation are provided in the following Table C1.

TABLE C1
Comparative Refrigerants Tested for Performance

| Refrig- | R1234ze(E) | R1233zd(E) | R134a | GWP | |
|---|---|---|---|---|---|
| erant | (wt %) | (wt %) | (wt %) | (AR4) | Flammability |
| C1 | 73 | 17 | 10 | <150 | Flammable |
| C2 | 70 | 19 | 11 | 163 | ND since |
| | | | | | GWP >150 |

As seen from the data in Table C1 above, which is not admitted to be prior art, the blend C1 is able to achieve a GWP value of less than 150, but testing has revealed that it is not a Class A1 refrigerant. On the other hand, blend C2 has a GWP of greater than 150, and therefore is not acceptable for use in the preferred aspects of the present invention.

Also, for the purposes of comparison, three additional refrigerant blends outside of the scope of the refrigerants of the present invention were also tested/evaluated with respect to GWP. Each refrigerant was based on a combination of HFO-1234ze(E), HFO-1233zd (E) and HFC-134a (1,1,1,2-tetrafluoroethane), and the results of the testing/evaluation are provided in the following Table C2.

TABLE C2
Comparative Refrigerants Tested for Performance

| Refrig- | R1234ze(E) | R1233zd(E) | R134a | GWP | |
|---|---|---|---|---|---|
| erant | (wt %) | (wt %) | (wt %) | (AR4) | Flammability |
| C3 | 76 | 14 | 10 | 148 | Flammable |
| C4 | 74 | 16 | 10 | 148 | Flammable |
| C5 | 72 | 18 | 10 | 148 | Flammable |

As seen from the data in Table C2 above, which is not admitted to be prior art, each of blends C3-C5 is able to achieve a GWP value of less than 150, but testing has revealed that not one of these blends is a Class A1 refrigerant.

### Example 1A: Performance in Medium Temperature Refrigeration System

Refrigerants R1 to R6 were performance tested in a medium temperature refrigeration system having a basic configuration as illustrated in FIG. 1A. The analysis was carried out to assess the evaporator glide and condenser glide of each of Refrigerants R1 to R6 in this system under typical medium temperature refrigeration conditions, with the results reported in Table E1A below.

Operating conditions were:

$$Condensing temperature ( refrigerant ) = 41 ° C .$$

$$Condensing Temperature = Ambient temperature + 10 ° C .$$

$$Condenser sub - cooling = 0. ° C . ( system with receiver )$$

$$Evaporating temperature ( refrigerant ) = - 6.7 ° C .$$

$$Evaporator Superheat = 5.5 ° C .$$

$$Compressor Isentropic Efficiency = 65 \%$$

$$Volumetric Efficiency = 100 \%$$

$$Temperature Rise in Suction Line ( from evaporator exit to compressor suction ) = 16.7 ° C .$$

TABLE E1A

| | Evaporator | Condenser |
|---|---|---|
| | Glide | Glide |
| Refrigerant | (° C.) | (° C.) |
| R1 | 9.2 | 9.9 |
| R2 | 9.3 | 10.1 |
| R3 | 8.8 | 9.4 |
| R4 | 8.6 | 9.2 |
| R5 | 9.5 | 10.4 |
| R6 | 9.8 | 10.9 |

### Example 1B: Performance in Medium Temperature Refrigeration System with and without Suction Line (SL)/Liquid Line (LL) Heat Exchanger (HX)

Refrigerants R1 to R6 were performance tested in a medium temperature refrigeration system with and without a suction line/liquid line heat exchanger (SL/LL HX). The analysis was carried out to assess the efficiency (COP) of Refrigerants R1 to R6 in this system at different levels of effectiveness of the SL-LL HX under the conditions below, with results reported in Table E1B below, including results for the use of R134a provided as a base-line (100%) for comparison purposes.

Operating conditions were:

$$Condensing temperature ( refrigerant ) = 45 ° C .$$

$$Condensing Temperature = Ambient temperature + 10 ° C .$$

$$Condenser sub - cooling = 0. ° C . ( system with receiver )$$

$$Evaporating temperature ( refrigerant ) = - 8 ° C . , \\ Corresponding box temperature = - 25 ° C .$$

$$Evaporator Superheat = 5.5 ° C .$$

$$Compressor Isentropic Efficiency = 65 \%$$

$$Volumetric Efficiency = 100 \%$$

$$Temperature Rise in Suction Line ( from evaporator exit to compressor suction ) = 10 ° C .$$

Suction Line/Liquid Line Heat Exchanger Effectiveness: 0%, 35%, 55%, 75%.

TABLE E1B
Performance in Medium-Temperature Refrigeration
System without and with SL/LL HX

| | Efficiency | Efficiency | Efficiency | Efficiency |
|---|---|---|---|---|
| Refrigerant | @0% | @35% | @55% | @75% |
| R134a | 100% | 100% | 100% | 100% |
| R1 | 103% | 104% | 104% | 104% |
| R2 | 104% | 104% | 104% | 104% |
| R3 | 103% | 103% | 103% | 104% |
| R4 | 103% | 103% | 103% | 103% |
| R5 | 104% | 104% | 104% | 104% |
| R6 | 104% | 104% | 104% | 104% |

It will be understood that the results under the column with “0%” efficiency for the SL-LL HX represent a system without a SL-LL HX, and that Refrigerants R1 to R6 show the most improved performance in terms of efficiency (COP) compared to R134a when a SL/LL Heat Exchanger is employed, with an improvement also when an SL/LL is not used, although to a lesser extent.

### Example 2: Performance in Low Temperature Refrigeration System with and without Suction Line/Liquid Line Heat Exchanger

Refrigerants R1 to R6 were performance tested in a low temperature refrigeration system with and without a suction line/liquid line heat exchanger (SL/LL HX) (see FIG. 5 for an example of a heat transfer system with a SL/LL HX). The analysis was carried out to assess the efficiency (COP) of Refrigerants R1 to R6 in this system at different levels of effectiveness of the SL-LL HX under the conditions below, with results reported in Table E2 below, including results for the use of R134a provided as a base-line (100%) for comparison purposes.

Operating conditions were:

$$Condensing temperature ( refrigerant ) = 45 ° C .$$

$$Condensing Temperature = Ambient Temperature + 10 ° C .$$

$$Condenser sub - cooling = 0. ° C . ( system with receiver )$$

$$Evaporating temperature = - 35 ° C . , \\ Corresponding box temperature = - 25 ° C .$$

$$Evaporator Superheat = 5.5 ° C .$$

$$Compressor Isentropic Efficiency = 65 \%$$

$$Volumetric Efficiency = 100 \%$$

$$Temperature Rise in Suction Line ( from evaporator exit to compressor suction ) = 10 ° C .$$

Suction Line/Liquid Line Heat Exchanger Effectiveness: 0%, 35%, 55%, 75%.

TABLE E2
Performance in Low-Temperature Refrigeration System without and with SL/LL HX

| | Efficiency@0% | Efficiency@35% | Efficiency@55% | Efficiency@75% |
|---|---|---|---|---|
| | SL-LL HX | SL-LL HX | SL-LL HX | SL-LL HX |
| Refrigerant | effectiveness | effectiveness | effectiveness | effectiveness |
| R134a | 100% | 100% | 100% | 100% |
| R1 | 103% | 103% | 103% | 104% |
| R2 | 103% | 103% | 104% | 104% |
| R3 | 102% | 103% | 103% | 103% |
| R4 | 102% | 103% | 103% | 103% |
| R5 | 103% | 104% | 104% | 104% |
| R6 | 103% | 104% | 104% | 104% |

It will be understood that the results under the column with “0%” efficiency for the SL-LL HX represent a system without a SL-LL HX, and that Refrigerants R1 to R6 show improved performance in terms of efficiency (COP) compared to R134a when a SL/LL Heat Exchanger is employed.

### Example 3: Performance in Medium Temperature Refrigeration System with Two-Stage Compressor and Vapor Injection

Refrigerants R1 to R6 were performance tested in a medium temperature refrigeration system with two stage injection compression. The analysis was carried out to assess the efficiency (COP) of Refrigerants R1 to R6 in this system under the conditions below, with results reported in Table E3 below, including results for the use of R134a provided as a baseline (100%) for comparison purposes.
Condensing temperature (refrigerant temperature)=45° C.
Condensing Temperature=Ambient Temperature+10° C.
Condenser sub-cooling=5.0° C.
Evaporating temperature: −8° C., Corresponding box temperature=1.7° C.
Evaporator Superheat=5.5° C.
Compressor Isentropic Efficiency: 70%
Volumetric Efficiency=100%
Temperature Rise in Suction Line (from evaporator exit to compressor suction)=10° C.
Vapor Injection Heat Exchanger (HX) Effectiveness: 15%, 35%, 55%, 75%.

TABLE E3
Performance in Medium-Temperature Refrigeration System
with Two-Stage Compression with Vapor Injection

| | Efficiency | Efficiency | Efficiency | Efficiency |
|---|---|---|---|---|
| | @15% vapor | @35% vapor | @55% vapor | @75% vapor |
| | injection HX | injection HX | injection HX | injection HX |
| Refrigerant | effectiveness | effectiveness | effectiveness | effectiveness |
| R134a | 100% | 100% | 100% | 100% |
| R1 | 104% | 104% | 104% | 104% |
| R2 | 104% | 104% | 104% | 104% |
| R3 | 103% | 103% | 104% | 104% |
| R4 | 103% | 103% | 103% | 104% |
| R5 | 104% | 104% | 104% | 104% |
| R6 | 104% | 104% | 104% | 105% |

Compositions R1 to R6 show improved performance in terms of efficiency (COP) compared to R134a in a system that uses two-stage compression with vapor injection.

### Example 4: Performance in CO2 Cascade Refrigeration System

Cascade systems are generally used in applications where there is a large temperature difference (e.g. about 50-80° C., such as about 60-70° C.) between the ambient temperature and the box temperature (e.g. the difference in temperature between the air-side of the condenser in the high stage, and the air-side of the evaporator in the low stage). For example, a cascade system (of the type illustrated generally in FIG. 2 hereof) may be used for freezing products in a supermarket. In the following Example, exemplary compositions of the invention R1-R6 were tested as the refrigerant in the high stage (i.e., as the medium temperature refrigerant for the MT cases) of a cascade refrigeration system, with results reported in Table E4 below, including results for the use of R134a in the high stage provided as a base-line (100%) for comparison purposes. The refrigerant used in the low stage of the system (LT cases in FIG. 2) in this example is carbon dioxide.

Operating conditions were:
Condensing temperature (high stage refrigerant)=45° C.
High-stage Condensing Temperature=Ambient Temperature+° C.
High-stage condenser sub-cooling=0.0° C.(system with receiver)
vEvaporating temperature (low stage refrigerant (CO2))=−30° C., Corresponding box temperature=−18° C.
Low-stage Evaporator Superheat=3.3° C.
High-stage and Low-stage Compressor lsentropic Efficiency: 65%
Volumetric Efficiency=100%
Temperature Rise in Suction Line Low Stage (from evaporator exit to low stage compressor suction)=15° C.
Temperature Rise in Suction Line High Stage (from intercircuit heat exchanger exit to high stage compressor suction)=10° C.
Intermediate Heat Exchanger CO2 Condensing Temperature=0° C., 5° C.and 10° C.
Intermediate Heat Exchanger Superheat=3.3° C.
Difference in Temperature in Intermediate Heat Exchanger (between CO2condensing temperature and high stage evaporating temperature)=8° C.

TABLE E4
Performance in CO2 Cascade Refrigeration System

| | Efficiency @ | Efficiency @ | Efficiency @ |
|---|---|---|---|
| Refrigerant | Tcond = 0° C. | Tcond = 5° C. | Tcond = 10° C. |
| R134a | 100% | 100% | 100% |
| R1 | 103% | 103% | 103% |
| R2 | 103% | 103% | 103% |
| R3 | 103% | 103% | 103% |
| R4 | 103% | 103% | 103% |
| R5 | 103% | 103% | 103% |
| R6 | 103% | 103% | 103% |

Table E4 shows the performance of refrigerants of the present invention R1-R6 in the high stage of a cascade refrigeration system. As can be seen, refrigerants R1 to R6 in all cases match or exceed the efficiency of the system with R134a in the high stage with three different condensing temperatures for the CO2 in the low stage cycle.

### Example 5: Performance in Vending Machines with Suction Line/Liquid Line Heat Exchanger

Refrigerants R1 to R6 were performance tested in a vending machine refrigeration system with and without a suction line/liquid line heat exchanger (SL/LL HX). The analysis was carried out to assess the efficiency (COP) of Refrigerants R1 to R6 in this system at different levels of effectiveness of the SL-LL HX under the conditions below, with results reported in Table E5 below, including results for the use of R134a provided as a base-line (100%) for comparison purposes.

Operating conditions:
Condensing temperature (refrigerant)=45° C.
Condensing Temperature=Ambient Temperature +10° C.
Condenser sub-cooling: 55° C.
Evaporating temperature: −8° C.,
Evaporator Superheat=3.500
Compressor lsentropic Efficiency: 60%
Volumetric Efficiency=100%
Temperature Rise in Suction Line (from evaporator exit to compressor suction)=5° C.
Suction Line/Liquid Line Heat Exchanger Effectiveness: 0%, 35%, 55%, 75%.

TABLE E5
Performance in Vending Machine with SL/LL HX

| | Efficiency @0% | Efficiency @35% | Efficiency @55% | Efficiency @75% |
|---|---|---|---|---|
| | SL-LL HX | SL-LL HX | SL-LL HX | SL-LL HX |
| Refrigerant | effectiveness | effectiveness | effectiveness | effectiveness |
| R134a | 100% | 100% | 100% | 100% |
| R1 | 103% | 103% | 103% | 104% |
| R2 | 103% | 103% | 104% | 104% |
| R3 | 103% | 103% | 103% | 103% |
| R4 | 102% | 103% | 103% | 103% |
| R5 | 103% | 103% | 104% | 104% |
| R6 | 103% | 104% | 104% | 104% |

Table E5 shows performance of refrigerants in a vending machine system with and without SL/LL HX. It will be understood that the results under the column with “0%” efficiency for the SL-LL HX represent a system without a SL-LL HX, and that Refrigerants R1 to R6 show improved performance in terms of efficiency (COP) relative to R134a when a SL/LL Heat Exchanger is employed.

### Example 6: Performance in Air-Source Heat Pump Water Heaters

Refrigerants R1 to R6 were performance tested in an air source heat pump water heater system. The analysis was carried out to assess the efficiency (COP) of Refrigerants R1 to R6 in this system under the conditions below, with results reported in Table E6 below, including results for the use of R134a provided as a baseline (100%) for comparison purposes.

Operating conditions were:
Condensing temperature (refrigerant)=55° C.
Water lnlet Temperature: 45° C., Water Outlet Temperature: 50° C.
Condenser sub-cooling=5.0° C.
Evaporating temperature: −5° C., Corresponding ambient temperature=10° C.
Evaporator Superheat=3.5° C.
Compressor Isentropic Efficiency: 65%
Volumetric Efficiency=100%
Temperature Rise in Suction Line (from evaporator exit to compressor suction)=5° C.

TABLE E6
Performance in Heat Pump Water Heaters

| | | Comp. Discharge |
|---|---|---|
| Refrigerant | Efficiency | Temp (° C.) |
| R134a | 100% | 88.0 |
| R1 | 104% | 87.5 |
| R2 | 104% | 87.5 |
| R3 | 103% | 87.1 |
| R4 | 103% | 86.9 |
| R5 | 104% | 87.8 |
| R6 | 104% | 88.2 |

Table E6 shows performance of refrigerants of the present invention in a heat pump water heater. Refrigerants R1 to R6 show efficiency similar to R134a. Refrigerants R1 to R6 each show lower discharge temperature than R134a, indicating better reliability for the compressor.

### Example 7: Performance in Air-Source Heat Pump Water Heaters with Suction

### Line/Liquid Line Heat Exchanger

Refrigerants R1 to R6 were performance tested in an air source heat pump water heater system with and without a suction line/liquid line heat exchanger (SL/LL HX). The analysis was carried out to assess the efficiency (COP) of Refrigerants R1 to R6 in this system at different levels of effectiveness of the SL-LL HX under the conditions below, with results reported in Table E7 below, including results for the use of R134a provided as a base-line (100%) for comparison purposes.

Operating conditions were:
Condensing temperature (refrigerant)=55° C.
Water lnlet Temperature: 45° C., Water Outlet Temperature: 50° C.
Condenser sub-cooling=5.0° C.
Evaporating temperature: −5° C., Corresponding ambient temperature=10° C.
Evaporator Superheat=3.5° C.
Compressor Isentropic Efficiency: 65%
Volumetric Efficiency=100%
Temperature Rise in Suction Line (from evaporator exit to compressor suction)=5° C.
Suction Line/Liquid Line Heat Exchanger Effectiveness: 35%, 55%, 75%.

TABLE E7
Performance in Heat Pump Water Heaters with SL/LL HX

| | SL-LL HX Eff. 35% | | SL-LL HX Eff. 55% | | SL-LL HX Eff. 75% | |
|---|---|---|---|---|---|---|
| | | Comp. | | Comp. | | Comp. |
| | | Discharge | | Discharge | | Discharge |
| | | Temp | | Temp | | Temp |
| Refrigerant | Efficiency | (° C.) | Efficiency | (° C.) | Efficiency | (° C.) |
| R134a | 100% | 105.5 | 100% | 115.5 | 100% | 125.3 |
| R1 | 104% | 101.7 | 104% | 109.6 | 104% | 117.4 |
| R2 | 104% | 101.6 | 104% | 109.5 | 105% | 117.3 |
| R3 | 104% | 101.4 | 104% | 109.5 | 104% | 117.4 |
| R4 | 104% | 101.3 | 104% | 109.4 | 104% | 117.3 |
| R5 | 104% | 101.9 | 105% | 109.7 | 105% | 117.4 |
| R6 | 105% | 102.1 | 105% | 109.8 | 105% | 117.5 |

Table E7 shows performance of refrigerants in a heat pump water heater with SL/LL HX, with each of refrigerants R1 to R6 showing higher efficiency than R134a when a SL/LL Heat Exchanger is employed. Refrigerants R1 to R6 each also show lower discharge temperature than R134a for all sl/ll hx efficiencies tested, indicating better reliability for the compressor.

### Example 8: Performance in Mobile Air Conditioning Systems (Buses, Trains, Cars)

Refrigerants R1 to R6 were performance tested in a mobile air conditioning system under various condenser temperature conditions. The analysis was carried out to assess the efficiency (COP) of Refrigerants R1 to R6 in this system under the conditions below, with results reported in Table E8 below, including results for the use of R134a provided as a baseline (100%) for comparison purposes.

Operating conditions:
Condensing temperature (refrigerant) =45° C. to 75° C.
Condenser sub-cooling: 5.0° C.
Evaporating temperature: 4° C., corresponding cabin temperature: 35° C.
Evaporator Superheat=5.0° C.
Compressor Isentropic Efficiency: 65%
Volumetric Efficiency: 100%
Temperature Rise in Suction Line =0° C.

TABLE E8
Performance in Mobile AC systems

| | Condensing | Condensing | Condensing | Condensing |
|---|---|---|---|---|
| | 45° C. | 55° C. | 65° C. | 75° C. |
| Refrigerant | Efficiency | Efficiency | Efficiency | Efficiency |
| R134a | 100% | 100% | 100% | 100% |
| R1 | 103% | 104% | 105% | 107% |
| R2 | 103% | 104% | 105% | 107% |
| R3 | 102% | 103% | 104% | 106% |
| R4 | 102% | 103% | 104% | 106% |
| R5 | 103% | 104% | 105% | 107% |
| R6 | 103% | 104% | 105% | 108% |

In Table E8, each of refrigerants R1 to R6 show in all conditions tested an improved efficiency compared to R134a, including over a range of condensing temperatures which correspond to different ambient temperatures.

### Example 9: Micro-Cascade Refrigeration System

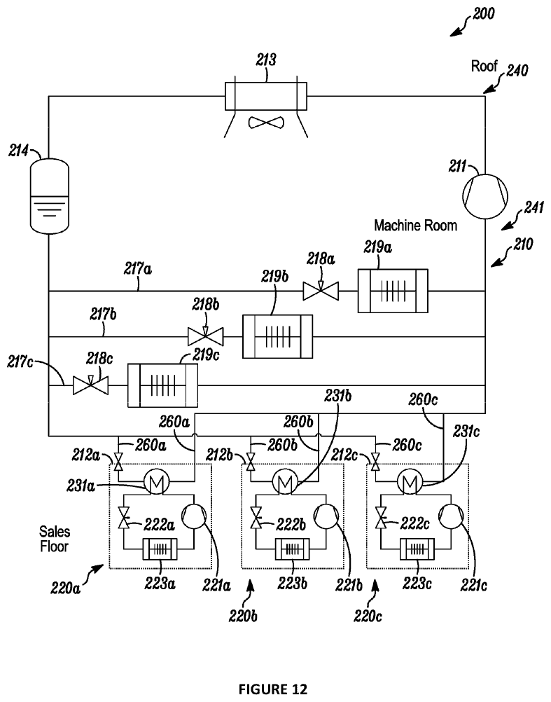

A micro-cascade system, a general example of which is illustrated in FIG. 12, combines a traditional medium temperature DX refrigeration system, with or without suction line liquid line heat exchanger (SLHX) in a cascade relationship with a low temperature refrigeration system. In the present example, and SLHX is used (but not shown in FIG. 12) and the upper stage (i.e., the medium stage) system uses the refrigerants of the present invention R1-R6, and this system is cascaded with plural (shown as three for convenience in FIG. 12) small low temperature stages, in the form of self-contained systems, using R1234yf, R455A and R454C as the low stage refrigerant. As used herein, the term “medium temperature DX refrigeration system” refers to a medium temperature system in which the evaporator is a dry evaporator, that is, it is not a flooded evaporator. A useful micro-cascade system is disclosed in U.S. Ser. No. 16/014,863 filed Jun. 21, 2018 and U.S. Ser. No. 16/015,145 filed Jun. 21, 2018, claiming priority to U.S. Ser. 62/522,386 filed Jun. 21, 2017, U.S. Ser. 62/522,846 filed Jun. 21, 2017, 62/522,851 filed Jun. 21, 2017, and Ser. 62/522,860 filed Jun. 21, 2017, all incorporated herein by reference in their entireties. The analysis was carried out to assess the efficiency (COP) of Refrigerants R1 to R6 in this system under the conditions below, with results reported in Table E9 below, including results for the use of R404A provided as a baseline (100%) refrigerant in the upper stage for comparison purposes.

Operating conditions were:

### Baseline R404A Combined MT and LT System

Refrigeration Capacity
   Low Temperature: 33,000W
   Medium Temperature: 67,000W
Volumetric efficiency: 95% for both MT and LT
Compressor Isentropic efficiency
   Medium Temperature=70% and Low Temperature=67%
Condensing temperature: 40.6° C.
Medium Temperature evaporation temperature: −6.7° C.
Low Temperature evaporation temperature: −28.9° F.
Evaporator superheat: 5.6° F. (both Medium and Low Temperature)
Suction line temperature rise (due to heat transfer to surroundings)
   Baseline: Medium Temperature: 13.9° F.; Low Temperature: 27.8° F.
   Cascade/self-contained without SLHX: Medium Temperature: 5.6° F.; Low Temperature: 13.9° F.
   Cascade/self-contained with SLHX: Medium Temperature: 5.6° F.; Low Temperature: 8.3° F.
SLHX efficiency when used: 65%.

TABLE 10
Comparison between R404A and the micro-cascade system

| | High stage | Low stage | Relative |
|---|---|---|---|
| | (medium | (Low | COP % |
| Systems | temperature) | temperature) | of R404A |
| R404A Base Line | R404A | R404A | 100% |
| Cascade with | R1 | R1234yf | 121% |
| R1234yf | R2 | R1234yf | 121% |
| | R3 | R1234yf | 121% |
| | R4 | R1234yf | 121% |
| | R5 | R1234yf | 121% |
| | R6 | R1234yf | 121% |
| Cascade with | R1 | R455A | 121% |
| R455A | R2 | R455A | 121% |
| | R3 | R455A | 120% |
| | R4 | R455A | 120% |
| | R5 | R455A | 121% |
| | R6 | R455A | 121% |
| Cascade with | R1 | R454C | 121% |
| R454C | R2 | R454C | 121% |
| | R3 | R454C | 120% |
| | R4 | R454C | 120% |
| | R5 | R454C | 121% |
| | R6 | R454C | 121% |

Table E9 above shows that the micro-cascade system using the present refrigerants has about 119% higher COP than a baseline medium temperature DX system with R404A.

### Example 10: Non-Flammable Secondary Refrigerants with Pressure Above Atmospheric Pressure

The inventive refrigerants, including each of Refrigerants R1-R6, or heat transfer compositions comprising a refrigerant of the present invention, including each of Refrigerants R1-R6, can work as secondary fluids in a liquid pumped secondary circuit of the type disclosed generally in FIGS. 7-10. The refrigerants of the invention, including each of Refrigerants R1-R6, have the necessary properties to ensure that the operating pressure of the refrigerant is not below atmospheric pressure at the given evaporator temperature, so that air would not enter the system and at the same time it is low enough to prevent significant leaks. The analysis was carried out to assess the pressure performance of Refrigerants R1 to R6 as a secondary refrigerant in this system under the conditions described below, with results reported in Table E10 below.
Table E10 shows the pressure of each refrigerants R1-R6 for evaporating temperatures ranging from −5° C. to 10° C. which cover the various operating conditions for air conditioning applications.
It can be observed from the table that each of refrigerants R1-R6 in the secondary loop maintains pressure higher than atmospheric pressure.
The primary refrigerant used in the vapor compression loop may be selected from the group consisting of R404A, R507, R410A, R455A, R32, R466A, R44B, R290, R717, R452B, R448A, R1234ze(E), R1234yf and R449A.
The temperature of the air (or body) to be cooled may be from about 25° C. to about 0° C.

TABLE E10
Secondary Refrigerant

| Secondary | Evaporator | Evaporator |
|---|---|---|
| Refrigerant | Temperature (° C.) | Pressure (bar) |
| R1 | −5 | 1.3 |
| | 0 | 1.5 |
| | 10 | 2.2 |
| R2 | −5 | 1.2 |
| | 0 | 1.5 |
| | 10 | 2.2 |
| R3 | −5 | 1.3 |
| | 0 | 1.6 |
| | 10 | 2.3 |
| R4 | −5 | 1.3 |
| | 0 | 1.6 |
| | 10 | 2.3 |
| R5 | −5 | 1.2 |
| | 0 | 1.5 |
| | 10 | 2.2 |
| R6 | −5 | 1.2 |
| | 0 | 1.5 |
| | 10 | 2.1 |

### Example 11: Performance in Stationary Air Conditioning Systems

Refrigerants R1 to R6 were performance tested in a stationary air conditioning system (having a basic structure as illustrated for example in FIG. 1A) under various condenser temperature conditions. The analysis was carried out to assess the efficiency (COP) of Refrigerants R1 to R6 in this system under the conditions below, with results reported in Table E11 below, including results for the use of R134a provided as a base-line refrigerant (100%) for comparison purposes.

Operating conditions were:
Condensing temperature: 45° C. to 65° C.
Condenser sub-cooling: 5.0° C.
Evaporating temperature: 10° C., corresponding indoor room temperature: 35° C.
Evaporator Superheat=5.0° C.
Compressor Isentropic Efficiency: 72%
Volumetric Efficiency: 100%

TABLE E11
Performance in Stationary AC systems

| | Condensing | Condensing | Condensing |
|---|---|---|---|
| | 45° C. | 55° C. | 65° C. |
| Refrigerant | Efficiency | Efficiency | Efficiency |
| R134a | 100% | 100% | 100% |
| R1 | 103% | 104% | 105% |
| R2 | 103% | 104% | 105% |
| R3 | 103% | 103% | 104% |
| R4 | 102% | 103% | 104% |
| R5 | 103% | 104% | 105% |
| R6 | 103% | 104% | 106% |

As revealed in the table above, each of refrigerants R1 to R6 show efficiency better than R134a over range of condensing temperatures which correspond to different ambient temperatures.

### Example 12: Performance in Commercial Air Conditioning Systems

Refrigerants R1 to R6 were performance tested in a commercial air conditioning system (having a basic structure as illustrated for example in FIG. 1A) under various condenser temperature conditions. The analysis was carried out to assess the efficiency (COP) of Refrigerants R1 to R6 in this system under the conditions below, with results reported in Table E12 below, including results for the use of R134a provided as a base-line refrigerant (100%) for comparison purposes.

Operating conditions were:
Condensing temperature: 45° C. to 65° C.
Condenser sub-cooling: 5.0° C.
Evaporating temperature: 10° C.,
Evaporator Superheat=5.0° C.
Compressor Isentropic Efficiency: 72%
Volumetric Efficiency: 100%

TABLE E12
Performance in Commercial AC systems

| | Condensing | Condensing | Condensing |
|---|---|---|---|
| | 45° C. | 55° C. | 65° C. |
| Refrigerant | Efficiency | Efficiency | Efficiency |
| R134a | 100% | 100% | 100% |
| R1 | 103% | 104% | 105% |
| R2 | 103% | 104% | 105% |
| R3 | 103% | 103% | 104% |
| R4 | 102% | 103% | 104% |
| R5 | 103% | 104% | 105% |
| R6 | 103% | 104% | 106% |

Each of refrigerants R1 to R6 show efficiency better than R134a over range of condensing temperatures which correspond to different ambient temperatures.

### Example 13: Performance in Transport (Refrigerated Trucks, Containers) Medium Temperature Refrigeration Applications with and without Suction Line (SL)/Liquid Line (LL) Heat Exchanger (HX)

Refrigerants R1 to R6 were performance tested in a transport refrigeration system with and without a suction line/liquid line heat exchanger (SL/LL HX) at medium temperature refrigeration conditions. The analysis was carried out to assess the efficiency (COP) of each of Refrigerants R1 to R6 in this system at different levels of effectiveness of the SL-LL HX under the conditions below, with results reported in Table E13 below, including results for the use of R134a provided as a base-line refrigerant (100%) for comparison purposes.

Operating conditions were:
Condensing temperature: 45° C.
Condensing Temperature−Ambient Temperature: 10° C.
Condenser sub-cooling: 0.0° C. (system with receiver)
Evaporating temperature: −8° C.,
Evaporator Superheat=5.5° C.
Compressor lsentropic Efficiency: 65%
Volumetric Efficiency: 100%
Temperature Rise in Suction Line =15° C.
Suction Line/Liquid Line Heat Exchanger Effectiveness: 0%, 35%, 55%, 75%.

TABLE E13
Performance in Medium-Temperature Transport
Refrigeration System with SL/LL HX

| | Efficiency @0% | Efficiency @35% | Efficiency @55% | Efficiency @75% |
|---|---|---|---|---|
| | SL-LL HX | SL-LL HX | SL-LL HX | SL-LL HX |
| Refrigerant | effectiveness | effectiveness | effectiveness | effectiveness |
| R134a | 100% | 100% | 100% | 100% |
| R1 | 104% | 104% | 104% | 104% |
| R2 | 104% | 104% | 104% | 104% |
| R3 | 103% | 103% | 103% | 103% |
| R4 | 103% | 103% | 103% | 103% |
| R5 | 104% | 104% | 104% | 104% |
| R6 | 104% | 104% | 104% | 104% |

It will be understood that the results in Table E13 under the column with “0%” efficiency for the SL-LL HX represent a system without a SL-LL HX, and that each of refrigerants R1 to R6 show improved performance in terms of efficiency (COP) than R134a when a SL/LL Heat Exchanger is employed and also that improvement is achieve, albeit to a lesser extent, when no SL/LL Heat Exchanger is present.

### Example 14: Performance in Transport (Refrigerated Trucks, Containers) Low Temperature Refrigeration Applications with and without Suction Line/Liquid Line Heat Exchanger

Each of refrigerants R1 to R6 were performance tested in a transport refrigeration system with and without a suction line/liquid line heat exchanger (SL/LL HX) at low temperature refrigeration conditions. The analysis was carried out to assess the efficiency (COP) of Refrigerants R1 to R6 in this system at different levels of effectiveness of the SL-LL HX under the conditions below, with results reported in Table E14 below, including results for the use of R134a provided as a base-line refrigerant (100%) for comparison purposes.

Operating conditions were:
Condensing temperature: 45° C.
Condensing Temperature<Ambient Temperature: 10° C.
Condenser sub-cooling=0.0° C. (system with receiver)
Evaporating temperature: −35° C., Corresponding box temperature=-25° C.
Evaporator Superheat=5.5° C.
Compressor Isentropic Efficiency: 65%
Volumetric Efficiency=100%
Temperature Rise in Suction Line =15° C.
Suction Line/Liquid Line Heat Exchanger Effectiveness: 0%, 35%, 55%, 75%.

TABLE E14
Performance in Low-Temperature Transport Refrigeration System with SL/LL HX

| | Efficiency@0% | Efficiency@35% | Efficiency@55% | Efficiency@75% |
|---|---|---|---|---|
| | SL-LL HX | SL-LL HX | SL-LL HX | SL-LL HX |
| Refrigerant | effectiveness | effectiveness | effectiveness | effectiveness |
| R134a | 100% | 100% | 100% | 100% |
| R1 | 103% | 103% | 103% | 103% |
| R2 | 103% | 103% | 103% | 104% |
| R3 | 102% | 103% | 103% | 103% |
| R4 | 102% | 103% | 103% | 103% |
| R5 | 103% | 103% | 104% | 104% |
| R6 | 104% | 104% | 104% | 104% |

It will be understood that the results under the column with “0%” efficiency for the SL-LL HX represent a system without a SL-LL HX, and that each of refrigerants R1 to R6 show improved performance in terms of efficiency (COP) compared to R134a when a SL/LL Heat Exchanger is employed.

### Example 15: Electronic Cooling-Heat Pipe

Each of refrigerants R1 to R6 are performance tested to evaluate cooling of electronic equipment (including in the cooling of chips, electronic boards, batteries (including batteries used in cars, trucks, buses and other electronic transport vehicles), computers, and the like), including in the form of a heat pipe, a thermosiphon and the like, as well as vapor compression cooling. The analysis is carried out to assess the performance of Refrigerants R1 to R6 in these applications. Refrigerants R1 to R6 show performance similar to R134a.

### Example 16—Electronic Cooling—Performance in Precision Data Center Cooling System

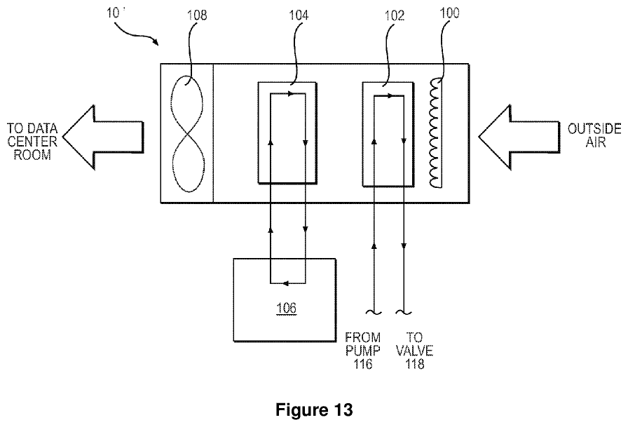

Refrigerants R1 to R6 are performance tested in a precision data center cooling system of the type generally illustrated FIG. 13 with the refrigerants of the present invention being used in a vapor compression cycle 106 with heat exchanger 104 acting as the evaporator for cooling of the air for the data center room. The analysis was carried out to assess the efficiency (COP) of Refrigerants R1 to R6 in this system under the conditions below, with results reported in Table E16 below, including results for the use of R134a provided as a baseline (100%) for comparison purposes.

Operating conditions were:
Condensing temperature (refrigerant)=45° C.
Condenser air supply temperature=25° C.
Condenser sub-cooling=5° C.
Evaporating temperature (refrigerant)=18° C., Corresponding air temperature =25° C.
Evaporator Superheat=5.500
Compressor lsentropic Efficiency: 65%
Volumetric Efficiency=100%
Temperature Rise in Suction Line (from evaporator exit to compressor suction) =° C.

TABLE E18
Performance in Precision Data Cooling System

| | | Evaporator | Condenser | Pressure |
|---|---|---|---|---|
| Refrigerant | Efficiency | Glide (° C.) | Glide (° C.) | ratio |
| R134a | 100% | 0 | 0 | 100% |
| R1 | 103% | 9.7 | 9.8 | 107% |
| R2 | 103% | 9.8 | 9.9 | 107% |
| R3 | 103% | 9.2 | 9.3 | 107% |
| R4 | 103% | 9.0 | 9.0 | 107% |
| R5 | 103% | 10.1 | 10.3 | 108% |
| R6 | 103% | 10.5 | 10.7 | 108% |

Refrigerants R1 to R6 show improved performance in terms of efficiency (COP) compared to R134a, similar pressure ratio, and an evaporator glide of less than 5.5° C. for all refrigerants, with refrigerants R2, R4 and R6 all showing an evaporator glide of less than 5° C.

### Example 17: Electronic Cooling-Performance of Pumped Two-Phase Cold Plate Cooling System for Computer Chip Cooling in Data Center

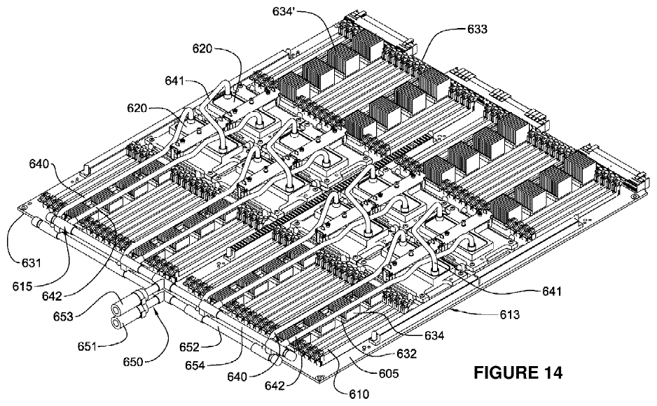

Refrigerants R1 to R6 were performance tested in a pumped two-phase cold plate cooling system for computer chip cooling in the data center of the type generally depicted in FIG. 14 wherein the cold refrigerant of the present invention is pumped into the cold plate via inlet manifold 651 and in which the cold plate evaporates the present refrigerants which exit the cold plate via outlet manifold 653. The refrigerant is then condensed in a condenser (not shown) and pumped back to the cold plate via a liquid pump (not shown) to repeat the cycle. The analysis was carried out to assess the capacity (for a fixed pump displacement) of Refrigerants R1 to R6 in this system under the conditions below, with results reported in Table E17 below, including results for the use of R-1234ze (E) provided as a baseline (100%) for comparison purposes.

Operating conditions were:
Supply temperature to cold plate=25° C.
Inlet quality to evaporator=Saturated liquid
Evaporator outlet quality: 70%

TABLE E17
Performance in pumped two-phase cold plate cooling system

| | | Temperature | Evaporator |
|---|---|---|---|
| Refrigerant | Capacity | Glide (° C.) | pressure |
| R1234ze(E) | 100% | 0.0 | 100% |
| R1 | 112% | 6.2 | 86% |
| R2 | 112% | 6.4 | 85% |
| R3 | 111% | 5.8 | 87% |
| R4 | 111% | 5.6 | 88% |
| R5 | 112% | 6.6 | 85% |
| R6 | 113% | 7.0 | 84% |

Refrigerants R1 to R6 show improved performance in terms of capacity compared to R1234ze(E), similar evaporation pressure, and an evaporator glide of about 5° C.

### Example 18: Performance in Retrofitting Medium Temperature Refrigeration System with Dedicated Mechanical Subcooling System

Each of refrigerants R1 to R6 were performance tested in a medium temperature refrigeration system with Dedicated Mechanical Subcooling System (DMSS) of the type illustrated in FIG. 11 (see the DMSS identified as item 6 in the drawing). Analysis was carried out to assess the efficiency (COP) of each of Refrigerants R1 to R6 in this system using various DMSS refrigerants, including each of R455A, R454C, R1234yf and R1234ze(E), under the conditions identified below. The results are reported in Table E18 below, including results for the use of R404A provided as a base-line refrigerant (100%) for comparison purposes.

Operating conditions were:
Condensing temperature: 40° C.
Condenser sub-cooling: 0.0° C.
Liquid sub-cooling=35° C. with DMSS
Cooling capacity: 100% for baseline R404A, 70% for cabinet with door.
Heat exchanger is optimized for load change.
Evaporator Superheat=55° C.
Compressor Isentropic Efficiency: 65%
Volumetric Efficiency: 100%
Temperature Rise in Suction Line=10° C.
DMSS with evaporating temperature=−5° C.
DMSS Condensing temperature=40° C.
DMSS Evaporating temperature=−5° C.
DMSS cooling capacity=Flow Rate*Liquid Line Enthalpy Change
DMSS Compressor Isentropic Efficiency: 65%
DMSS Volumetric Efficiency: 100%
DMSS Temperature Rise in Suction Line =10° C.

TABLE E18

| | R455A | R454C | R1234yf | R1234ze(E) |
|---|---|---|---|---|
| Refrigerant | in DMSS | in DMSS | in DMSS | in DMSS |
| R404A | 100% | 100% | 100% | 100% |
| R1 | 136% | 136% | 137% | 139% |
| R2 | 137% | 137% | 137% | 139% |
| R3 | 136% | 136% | 137% | 138% |
| R4 | 136% | 136% | 136% | 138% |
| R5 | 137% | 137% | 137% | 139% |
| R6 | 137% | 137% | 137% | 139% |

### Example 19: Performance in High Temperature Heat Pump

Each of refrigerants R1 to R6 were performance tested in High Temperature Heat Pump. The analysis was carried out to assess the heating efficiency (COP) of each of refrigerants R1 to R6 in this system at different condensing temperature under the conditions below, with results reported in Table E19 below, including results for the use of R1234ze(E) provided as a base-line refrigerant (100%) for comparison purposes.

Operating conditions were:
Condenser sub-cooling: 10.0° C.
Evaporating temperature: 5° C.
Evaporator Superheat=5.5° C.
Compressor Isentropic Efficiency: 65%

TABLE E19

| | Heating COP | | |
|---|---|---|---|
| Refrigerant | Tcond = 90° C. | Tcond = 100° C. | Tcond = 105° C. |
| R1234ze(E) | 100% | 100% | 100% |
| R1 | 106% | 108% | 109% |
| R2 | 106% | 108% | 110% |
| R3 | 106% | 107% | 109% |
| R4 | 105% | 107% | 108% |
| R5 | 106% | 108% | 110% |
| R6 | 107% | 109% | 110% |

Each of refrigerants R1 to R6 show efficiency better than R1234ze over range of condensing temperatures.

What is claimed is:

1. A refrigerant consisting essentially of:
(a) from about 50% to less than 70% by weight of HFO-1234ze(E),
(b) from 1% to 10.5% by weight of HFC-134a; and
(c) from about 25% to about 42% of HFCO-1233zd(E),
wherein said refrigerant is an A1 or an A2L refrigerant and has a GWP of 150 or less.

2. The refrigerant of claim 1 wherein said refrigerant is an A1 refrigerant.

3. The refrigerant of any of claim 2 wherein the refrigerant consists essentially of:
(a) from about 55% to about 65% by weight of HFO-1234ze(E),
(b) from 1% to 10.5% by weight of HFC-134a; and
(c) from 25% to about 35% of HFCO-1233zd(E).

4. The refrigerant of claim 1 wherein the refrigerant consists essentially of:
(a) from about 56% to less than 64% by weight of HFO-1234ze(E),
(b) from 8% to 10.5% by weight of HFC-134a; and
(c) from 26% to about 36% of HFCO-1233zd(E).

5. The refrigerant of claim 1 wherein the refrigerant consists essentially of:
(a) from 58% to 61% by weight of HFO-1234ze(E),
(b) from 9% to 10.5% by weight of HFC-134a; and
(c) from 29% to about 32% of HFCO-1233zd(E).

6. The refrigerant of claim 1 wherein the refrigerant consists essentially of:
(a) 60%+0.3%/−2.0% by weight of HFO-1234ze(E),
(b) 10%+1.5%/−0.5% by weight of HFC-134a;
(c) 30%+1.5%/−0.5% of HFCO-1233zd(E).

7. A medium temperature refrigeration system comprising a refrigerant according to claim 6.

8. A low temperature refrigeration system comprising a refrigerant according to claim 6.

9. A cascade system comprising a refrigerant according to claim 6.

10. A vending machine comprising a refrigerant according to claim 6.

11. A heat pump comprising a refrigerant according to claim 6.

12. A mobile air conditioning system comprising a refrigerant according to claim 6.

13. A stationary air conditioning system comprising a refrigerant according to claim 6.

14. A transport refrigeration system comprising a refrigerant according to claim 6.

15. A method of providing heating and/or cooling comprising:
(a) providing a refrigeration system comprising a vapor compression refrigeration circuit comprising a compressor, a condenser, an evaporator and a refrigerant, wherein said refrigerant is a refrigerant according to claim 1; and
(b) evaporating said refrigerant in said evaporator to provide cooling or condensing said refrigerant in said condenser to provide heating, wherein the COP of said refrigerant in said system is at least about 100% compared to R-134a in said system.

16. A method of providing heating and/or cooling comprising:
(a) providing a refrigeration system comprising a vapor compression refrigeration circuit comprising a compressor, a condenser, an evaporator and a refrigerant, wherein said refrigerant is a refrigerant according to claim 1; and
(b) evaporating said refrigerant in said evaporator to provide cooling or condensing said refrigerant in said condenser to provide heating, wherein the COP of said refrigerant in said system is at least about 100% compared to R-404A in said system.

17. A heat transfer system providing heating and/or cooling comprising:
(a) a vapor compression refrigeration circuit comprising a compressor, a condenser, an evaporator and a refrigerant, wherein said refrigerant is a refrigerant according to claim 1; and
(b) said refrigerant in said evaporator providing cooling or said refrigerant in said condenser providing heating, wherein the COP of said refrigerant in said system is at least about 100% compared to R-404A in said system.

18. A method of heating or cooling in an R-134a heat transfer system or in an R404A heat transfer system comprising:
a. providing an R-134a heat transfer system or an R404A heat transfer system comprising a compressor, an evaporator and a condenser;
b. heating and/or cooling by using in said heat transfer system a refrigerant comprising:
i. from about 50% to less than 70% by weight of HFO-1234ze (E),
ii. from 1% to 10.5% by weight of HFC-134a; and
iii. about 25% to about 42% of HFCO-1233zd(E),
wherein said refrigerant is an A1 refrigerant and has a GWP of 150 or less.

19. The method of claim 18 wherein said heat transfer system is an R-134a heat transfer system.

20. The method of claim 18 wherein said heat transfer system is an R404A heat transfer system.
